(19) United States
(12) Patent Application Publication
(10) Pub. No.: US 2024/0019650 A1
(43) Pub. Date: Jan. 18, 2024

(54) OPTICAL MODULE

(71) Applicant: HISENSE BROADBAND MULTIMEDIA TECHNOLOGIES CO., LTD., Qingdao (CN)

(72) Inventors: Long ZHENG, Qingdao (CN); Yuting DONG, Qingdao (CN); Sigeng YANG, Qingdao (CN); Shicong HAO, Qingdao (CN)

(73) Assignee: HISENSE BROADBAND MULTIMEDIA TECHNOLOGIES CO., LTD., Qingdao (CN)

(21) Appl. No.: 18/475,976

(22) Filed: Sep. 27, 2023

Related U.S. Application Data
(63) Continuation of application No. PCT/CN2022/103192, filed on Jun. 30, 2022.

(30) Foreign Application Priority Data
Nov. 30, 2021 (CN) 202111443415.2
Nov. 30, 2021 (CN) 202111443537.1
Nov. 30, 2021 (CN) 202111449769.8
Nov. 30, 2021 (CN) 202122977649.7
Nov. 30, 2021 (CN) 202122977650.X
Nov. 30, 2021 (CN) 202122993397.7

(51) Int. Cl. G02B 6/42

(52) U.S. Cl. CPC G02B 6/4277; G02B 6/428; G02B 6/4246

(57) ABSTRACT

An optical module includes a circuit board, a circuit sub-board, a signal processing chip, a first light transceiver assembly, and a second light transceiver assembly. The circuit board is configured to be electrically connected to an outside of the optical module. The circuit sub-board is disposed on the circuit board and electrically connected to the circuit board. The circuit sub-board includes a first body and a connecting hole. The connecting hole runs through an upper surface and a lower surface of the first body. The signal processing chip is disposed on the circuit sub-board. The first light transceiver assembly is disposed on the circuit board and located in the connecting hole. The second light transceiver assembly is disposed on the circuit board and located outside the connecting hole.

### CROSS-REFERENCE TO RELATED APPLICATIONS

This application is a continuation application of International Patent Application No. PCT/CN2022/103192, filed on Jun. 30, 2022, which claims priority to Chinese Patent Application No. 202111449769.8, filed on Nov. 30, 2021; Chinese Patent Application No. 202122993397.7, filed on Nov. 30, 2021; Chinese Patent Application No. 202122977650.X, filed on Nov. 30, 2021; Chinese Patent Application No. 202122977649.7, filed on Nov. 30, 2021; Chinese Patent Application No. 202111443537.1, filed on Nov. 30, 2021; and Chinese Patent Application No. 202111443415.2, filed on Nov. 30, 2021, which are incorporated herein by reference in their entireties.

### TECHNICAL FIELD

The present disclosure relates to the field of optical communication technologies and, in particular, to an optical module.

### BACKGROUND

With the development of new services and application scenarios such as cloud computing, mobile internet, and video conferencing, the development and progress of optical communication technologies have become increasingly important. In the optical communication technologies, an optical module is a tool for achieving interconversion between an optical signal and an electrical signal and is one of the key elements in an optical communication equipment. Moreover, with the development of optical communication technologies, a transmission rate of the optical module is continuously increasing.

### SUMMARY

In an aspect, an optical module is provided. The optical module includes a circuit board, a circuit sub-board, a signal processing chip, a first light transceiver assembly, and a second light transceiver assembly. The circuit board is configured to be electrically connected to an outside of the optical module. The circuit sub-board is disposed on the circuit board and electrically connected to the circuit board. The circuit sub-board includes a first body, a connecting hole, at least one first signal line, and at least one second signal line. A surface of the first body proximate to the circuit board is a lower surface, and a surface of the first body away from the circuit board is an upper surface. The connecting hole runs through the upper surface and the lower surface of the first body. The first signal line is disposed on the upper surface of the first body, and an end of the first signal line is located at an edge of the connecting hole proximate to the signal processing chip. The second signal line is disposed on the upper surface of the first body. An end of the second signal line is located at an edge of the first body away from the signal processing chip. The signal processing chip is disposed on the circuit sub-board. The signal processing chip is electrically connected to another end of the first signal line, and the signal processing chip is electrically connected to another end of the second signal line. The first light transceiver assembly is disposed on the circuit board and located in the connecting hole. The first light transceiver assembly is electrically connected to the end of the first signal line. Pads of the first light transceiver assembly are substantially coplanar with the upper surface of the first body, so as to shorten lengths of connecting wires between the first light transceiver assembly and the circuit sub-board. The second light transceiver assembly is disposed on the circuit board and located outside the connecting hole. The second light transceiver assembly is electrically connected to the end of the second signal line. Pads of the second light transceiver assembly is substantially coplanar with the upper surface of the first body, so as to shorten lengths of connecting wires between the second light transceiver assembly and the circuit sub-board.

In another aspect, an optical module is provided. An optical module includes a circuit board, at least one circuit sub-board, a light transceiver assembly, and at least one signal processing chip. The circuit board is configured to be electrically connected to an outside of the optical module. At least one circuit sub-board is disposed on the circuit board and electrically connected to the circuit board. The circuit sub-board includes a first body, a connecting hole, and a signal line. The connecting hole is disposed at an end of the first body. The signal line is disposed on the upper surface of the first body, and an end of the signal line is located at an edge of the connecting hole proximate to the at least one signal processing chip. The light transceiver assembly is disposed on the circuit board, and at least a portion of the light transceiver assembly is located in the connecting hole. The light transceiver assembly is electrically connected to the end of the signal line. Pads of the light transceiver assembly are substantially coplanar with the upper surface of the first body, so as to shorten lengths of connecting wires between the light transceiver assembly and the circuit sub-board. The at least one signal processing chip is disposed on the circuit sub-board, and the signal processing chip is electrically connected to another end of the signal line.

### BRIEF DESCRIPTION OF THE DRAWINGS

In order to describe the technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams but are not limitations on an actual size of a product, an actual process of a method, and an actual timing of a signal involved in the embodiments of the present disclosure.

FIG. 1 is a diagram showing a structure of an optical module, in accordance with some embodiments:

FIG. 2 is an exploded view of an optical module, in accordance with some embodiments;

FIG. 3 is a diagram showing structures of a circuit board, a light transceiver assembly, an optical fiber strip, and a fiber optic adapter in an optical module, in accordance with some embodiments;

FIG. 4 is a top view of the optical module in FIG. 3;

FIG. 5 is an exploded view of a circuit board, a circuit sub-board, a first light transceiver assembly, and a second light transceiver assembly in an optical module, in accordance with some embodiments;

FIG. 6 is a diagram showing a structure of a circuit sub-board in an optical module, in accordance with some embodiments;

FIG. 7 is an assembly diagram of a circuit sub-board and a first light transceiver assembly in an optical module, in accordance with some embodiments;

FIG. 8 is a partial exploded view of a circuit board, a circuit sub-board, a first light transceiver assembly, and a second light transceiver assembly in an optical module, in accordance with some embodiments;

FIG. 9A is a partial exploded view of a first light transceiver assembly in an optical module, in accordance with some embodiments;

FIG. 9B is a partial exploded view of a second light transceiver assembly in an optical module, in accordance with some embodiments;

FIG. 10A is a top view of a first light transceiver assembly in an optical module, in accordance with some embodiments;

FIG. 10B is atop view of a second light transceiver assembly in an optical module, in accordance with some embodiments;

FIG. 11A is a diagram showing a structure of a first silicon optical chip in an optical module, in accordance with some embodiments;

FIG. 11B is a diagram showing a structure of a second silicon optical chip in an optical module, in accordance with some embodiments;

FIG. 12 is a diagram showing a structure of a first housing in an optical module, in accordance with some embodiments;

FIG. 13 is a partial exploded view of a circuit sub-board and a first light transceiver assembly in an optical module, in accordance with some embodiments;

FIG. 14 is a diagram showing a structure of a fixing frame in an optical module, in accordance with some embodiments;

FIG. 15 is a diagram showing partial structures of a circuit board, a first light transceiver assembly, a second light transceiver assembly, a first optical fiber strip, and a second optical fiber strip in an optical module, in accordance with some embodiments;

FIG. 16 is a diagram showing a partial structure of another optical module, in accordance with some embodiments;

FIG. 17 is an exploded view of a circuit sub-board and a signal processing chip in an optical module, in accordance with some embodiments;

FIG. 18 is a sectional view of a circuit board, a circuit sub-board, and a signal processing chip in an optical module, in accordance with some embodiments;

FIG. 19 is another exploded view of a circuit sub-board and a signal processing chip in an optical module, in accordance with some embodiments;

FIG. 20 is another sectional view of a circuit board, a circuit sub-board, and a signal processing chip in an optical module, in accordance with some embodiments;

FIG. 21 is a diagram showing partial structures of a first silicon optical chip and a signal processing chip in an optical module, in accordance with some embodiments;

FIG. 22 is a diagram showing partial structures of a first silicon optical chip and a circuit sub-board in an optical module, in accordance with some embodiments;

FIG. 23 is a diagram showing partial structures of a second silicon optical chip and a circuit sub-board in an optical module, in accordance with some embodiments;

FIG. 24 is a diagram showing partial structures of a circuit board, a circuit sub-board, a signal processing chip, and a first light transceiver assembly in an optical module, in accordance with some embodiments;

FIG. 25 is a sectional view of a circuit board, a circuit sub-board, a signal processing chip, and a first light transceiver assembly in an optical module, in accordance with some embodiments:

FIG. 26 is a diagram showing partial structures of a circuit board, a circuit sub-board, a signal processing chip, a first light transceiver assembly, and a second light transceiver assembly in an optical module, in accordance with some embodiments;

FIG. 27 is a sectional view of a circuit board, a circuit sub-board, a first light transceiver assembly, and a second light transceiver assembly in an optical module, in accordance with some embodiments; and

FIG. 28 is a diagram showing a structure of a circuit sub-board in an optical module, in accordance with some embodiments.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the description and the claims, the term “comprise” is construed as an open and inclusive meaning, i.e., “including, but not limited to.” The terms such as “first” and “second” are not to be construed as indicating or implying the relative importance or indicating the upper limit of the number. The term “a plurality of” or “the plurality of” means two or more. The term “connected” should be understood in a broad sense. For example, the term “connected” may represent a fixed connection, a detachable connection, or a one-piece connection, or may represent a direct connection, or may represent an indirect connection through an intermediate medium. The use of the phase “applicable to” or “configured to” herein means an open and inclusive expression, which does not exclude devices that are applicable to or configured to perform additional tasks or steps. The terms such as “parallel,” “perpendicular,” “same,” “consistent,” and “flush,” are not limited to absolute mathematical theoretical relationships, but also includes acceptable error ranges generated in practice, as well as differences based on the same design conception but due to manufacturing reasons.

In the optical communication technology, in order to establish information transmission between information processing equipment, it is necessary to load information into the light and use the propagation of the light in information transmission equipment to achieve information transmission. Here, the light loaded with information is an optical signal. The information processing equipment usually includes optical network units, optical line terminal, gateways, routers, switches, servers, etc. The information transmission equipment usually includes optical fibers, optical waveguides, etc.

The signal that the information processing equipment can recognize and process is an electrical signal. An optical module is configured to achieve mutual conversion of optical signals and electrical signals between the information processing equipment and the information transmission equipment. The information processing equipment directly connected to the optical module is referred to as a master monitor of the optical module. One-way electrical signal connection or bidirectional electrical signal connection between the master monitor and the optical module is established.

A first optical signal from remote information processing equipment is transmitted to the optical module through the optical fiber. The optical module converts the first optical signal into a first electrical signal. The optical module transmits the first electrical signal to the master monitor. A second electrical signal from the master monitor is transmitted to the optical module, the optical module converts the second electrical signal into a second optical signal, and transmits the second optical signal to the optical fiber. The second optical signal is transmitted to the remote information processing equipment through the optical fiber. During the conversion process of the above optical signal and electrical signal, the information does not change, and the encoding and decoding methods of information may change.

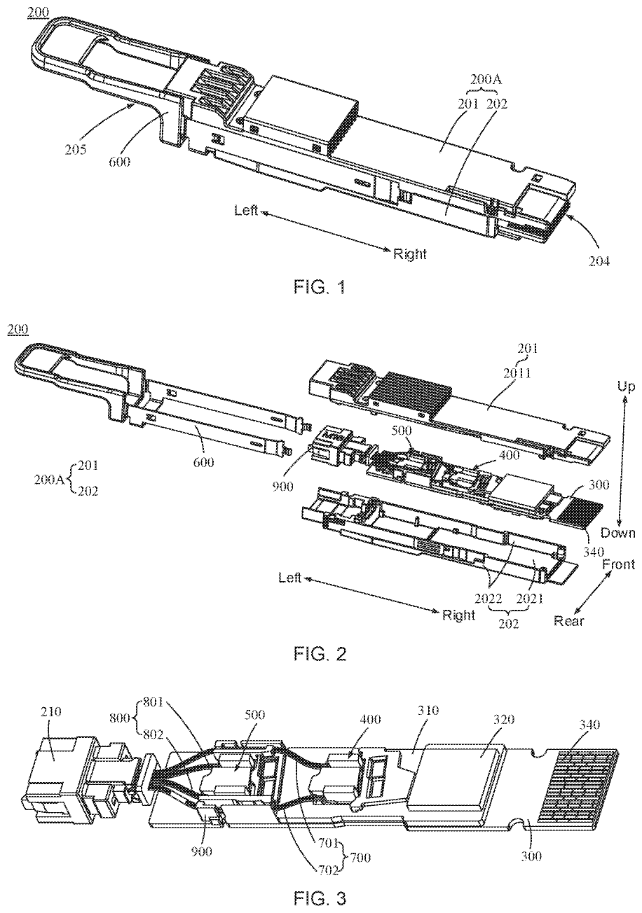

FIG. 1 is a diagram showing a structure of an optical module, in accordance with some embodiments. FIG. 2 is an exploded view of an optical module, in accordance with some embodiments. As shown in FIGS. 1 and 2, the optical module 200 includes a shell 200A and a circuit board 300 disposed in the shell 200A.

The shell 200A includes an upper shell 201 and a lower shell 202. The upper shell 201 is covered on the lower shell 202, so as to form a mounting cavity having two openings 204 and 205. The circuit board 300 is disposed in the mounting cavity. An outer contour of the shell 200A is generally in a cuboid shape.

A direction in which a connecting line between the two openings 204 and 205 is located may be the same as a length direction of the optical module 200 or may not be the same as the length direction of the optical module 200. For example, the opening 204 is located at an end (e.g., the right end in FIG. 1) of the optical module 200, and the opening 205 is also located at an end (e.g., the left end in FIG. 1) of the optical module 200. Alternatively, the opening 204 is located at an end of the optical module 200, and the opening 205 is located at a side of the optical module 200. The opening 204 is an electrical port, and a connecting finger of the circuit board 300 extends from the electrical port 204 and is inserted into an electrical connector of the master monitor. The opening 205 is the optical port and configured to connect to an external optical fiber.

By using an assembly manner of combining the upper shell 201 with the lower shell 202, it may be conducive to forming encapsulation and protection for the components inside the shell 200A. In some embodiments, the upper shell 201 and the lower shell 202 are made of a metal material, which is conducive to electromagnetic shielding and heat dissipation.

In some embodiments, as shown in FIGS. 1 and 2, the optical module 200 further includes an unlocking component 600 located outside the shell 200A thereof. The unlocking component 600 is configured to implement a fixed connection between the optical module 200 and the master monitor or to release a fixed connection between the optical module 200 and the master monitor.

The circuit board 300 includes circuit wirings, electronic elements, and chips, and the electronic elements and the chips are connected according to a circuit design through the circuit wirings, so as to implement functions such as power supply, transmission of the electrical signal, and grounding. The electronic element includes, for example, a capacitor, a resistor, a triode, and a metal-oxide-semiconductor field-effect transistor. The chips include, for example, a microcontroller unit, a laser driving chip, a transimpedance amplifier, a limiting amplifier, a clock and data recovery chip, or a digital signal processing chip.

The circuit board 300 is generally a rigid circuit board. Due to the relatively hard material of the rigid circuit board, the rigid circuit board may also achieve bearing effects. The circuit board 300 further includes a connecting finger 340 formed on a surface of an end thereof, and the connecting finger 340 is composed of a plurality of independent pins. The circuit board 300 is inserted into the master monitor and is conducted with the electrical connector in the master monitor through the connecting finger 340. The connecting finger 340 may be disposed on a surface (e.g., an upper surface shown in FIG. 2) of the circuit board 300. Alternatively, the connecting finger 340 may also be disposed on both upper and lower surfaces of the circuit board 300 to provide a larger number of pins, so as to adapt to an occasion where a large number of pins are needed. The connecting finger 340 is configured to establish an electrical connection with the master monitor, so as to implement power supply, grounding, inter-integrated circuit (I2C) signal transmission, and data signal transmission. Of course, flexible circuit boards are also used in some optical modules. The flexible circuit board is generally used in conjunction with the rigid circuit board as a supplement to the rigid circuit board.

In some embodiments, the optical module 200 further includes a plurality of light transceiver assemblies. For example, as shown in FIG. 2, the optical module 200 includes a first light transceiver assembly 400 and a second light transceiver assembly 500. However, the present disclosure is not limited thereto. In some embodiments, the optical module 200 may also include one, three, or more light transceiver assemblies.

In some embodiments, the first light transceiver assembly 400 and the second light transceiver assembly 500 may be disposed on a same side of the circuit board 300 in a thickness direction of the circuit board 300. Alternatively, the first light transceiver assembly 400 and the second light transceiver assembly 500 may also be disposed on two sides of the circuit board 300 in the thickness direction of the circuit board 300.

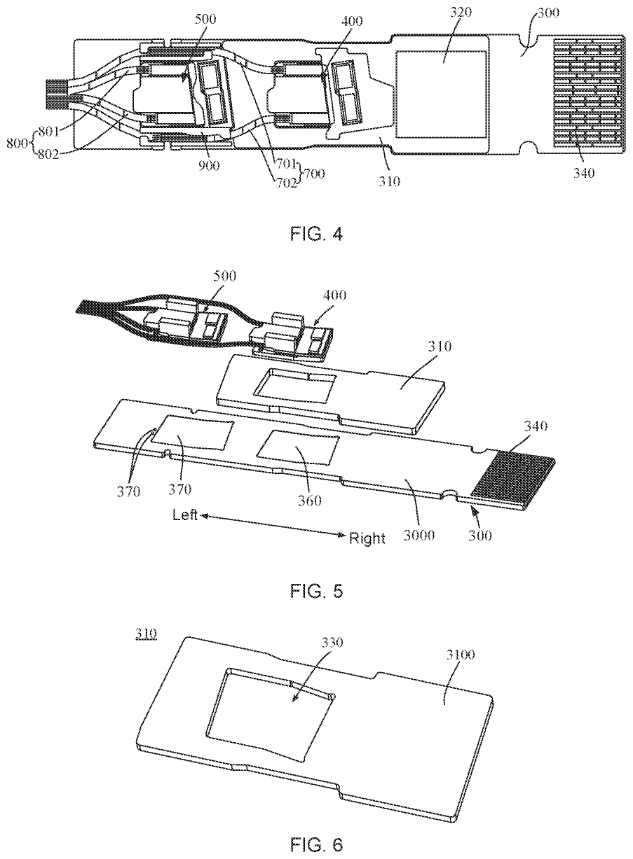

FIG. 3 is a diagram showing structures of a circuit board, a light transceiver assembly, an optical fiber strip, and a fiber optic adapter in an optical module, in accordance with some embodiments. FIG. 4 is a top view of an optical module in FIG. 3. As shown in FIGS. 3 and 4, the optical module 200 further includes a circuit sub-board 310, a signal processing chip 320, a first optical fiber strip 700, a second optical fiber strip 800, and a fiber optic adapter 210.

The circuit sub-board 310 is disposed on the circuit board 300 in a stack manner, and the signal processing chip 320 is disposed on the circuit sub-board 310. In some embodiments, surfaces of the circuit sub-board 310 and the circuit board 300 proximate to each other are attached to each other. For example, a lower surface of the circuit sub-board 310 is attached to an upper surface of the circuit board 300. The signal processing chip 320 (e.g., a digital signal processing (DSP) chip) is placed on a surface (e.g., an upper surface) of the circuit sub-board 310 away from the circuit board 300.

FIG. 5 is an exploded view of a circuit board, a circuit sub-board, a first light transceiver assembly, and a second light transceiver assembly in an optical module, in accordance with some embodiments. As shown in FIG. 5, the circuit board 300 includes a first mounting region 360 and a second mounting region 370. The second mounting region 370 and the first mounting region 360 are arranged side by side in a first direction (e.g., the left-right direction in FIG. 5), and the first mounting region 360 is closer to the connecting finger 340 on the circuit board 300 than the second mounting region 370. For example, the second mounting region 370 is located on a side of the first mounting region 360 away from the connecting finger 340. The first light transceiver assembly 400 is disposed on the first mounting region 360, and the second light transceiver assembly 500 is disposed on the second mounting region 370, so that the first light transceiver assembly 400 and the second light transceiver assembly 500 are mounted on the circuit board 300. In some examples, the first mounting region 360 and the second mounting region 370 may be grooves or mounting holes. The groove may run through the upper surface of the circuit board 300, and the mounting hole may run through the upper surface and the lower surface of the circuit board 300.

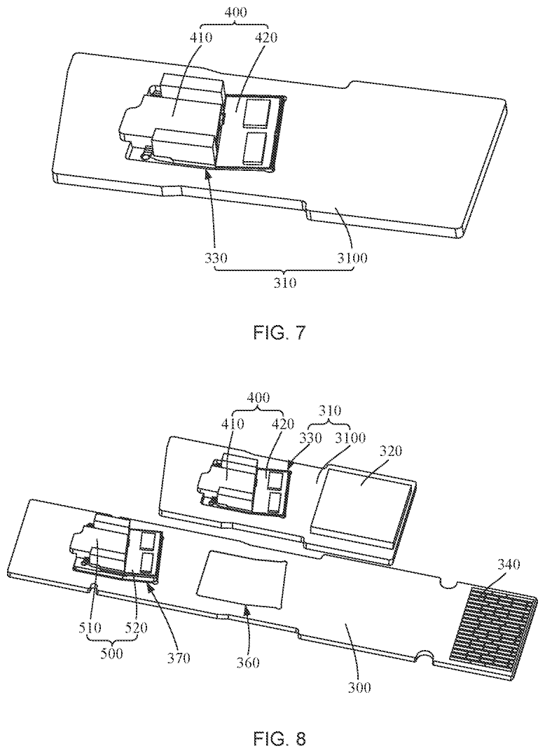

FIG. 6 is a diagram showing a structure of a circuit sub-board in an optical module, in accordance with some embodiments. FIG. 7 is an assembly diagram of a circuit sub-board and a first light transceiver assembly in an optical module, in accordance with some embodiments. As shown in FIGS. 6 and 7, the circuit sub-board 310 includes a first body 3100 and a connecting hole 330. The connecting hole 330 runs through an upper surface and a lower surface of the first body 3100. Here, a surface of the first body 3100 proximate to the circuit board 300 is the lower surface, and a surface of the first body 3100 away from the circuit board 300 is the upper surface. For example, the connecting hole 330 runs through the first body 3100 in a thickness direction (e.g., an up-down direction) of the circuit sub-board 310, so that the first mounting region 360 of the circuit board 300 is exposed through the connecting hole 330, and the first light transceiver assembly 400 may pass through the connecting hole 330 and be disposed on the first mounting region 360 of the circuit board 300.

For example, the first light transceiver assembly 400 is embedded in the connecting hole 330, and a surface of the first light transceiver assembly 400 proximate to the circuit board 300 (e.g., a lower surface) is attached to a surface of the first mounting region 360. In some examples, as shown in FIG. 5, in a length direction of the optical module 200, a length of the circuit sub-board 310 is less than that of the circuit board 300, and the circuit sub-board 310 is provided proximate to the connecting finger 340 of the circuit board 300. Here, as for the length direction of the optical module 200, reference may be made to the left-right direction in FIG. 5.

The first light transceiver assembly 400 is electrically connected to the signal processing chip 320 through the circuit sub-board 310, and an electrical signal output by the signal processing chip 320 is transmitted to the first light transceiver assembly 400, so that the first light transceiver assembly 400 may emit an optical signal. The electrical signal converted by the first light transceiver assembly 400 is transmitted to the signal processing chip 320 for subsequent processing.

The second light transceiver assembly 500 is electrically connected to the signal processing chip 320 through the circuit sub-board 310. The electrical signal output by the signal processing chip 320 is transmitted to the second light transceiver assembly 500, so that the second light transceiver assembly 500 may emit an optical signal, and the electrical signal converted by the second light transceiver assembly 500 is transmitted to the signal processing chip 320 for subsequent processing.

The first optical fiber strip 700 includes a first optical fiber sub-strip 701 and a second optical fiber sub-strip 702. An end of the first optical fiber sub-strip 701 is connected to the first light transceiver assembly 400, and another end of the first optical fiber sub-strip 701 is connected to the optical fiber adapter 210. The first optical fiber sub-strip 701 is configured to transmit the optical signal emitted by the first light transceiver assembly 400 to an outside of the optical module 200.

Correspondingly, an end of the second optical fiber sub-strip 702 is connected to the first light transceiver assembly 400, and another end of the second optical fiber sub-strip 702 is connected to the optical fiber adapter 210. The second optical fiber sub-strip 702 is configured to transmit the optical signal from the outside of the optical module 200 to the first light transceiver assembly 400.

Similarly, the second optical fiber strip 800 includes a third optical fiber sub-strip 801 and a fourth optical fiber sub-strip 802. An end of the third optical fiber sub-strip 801 is connected to the second light transceiver assembly 500, and another end of the third optical fiber sub-strip 801 is connected to the optical fiber adapter 210. The third optical fiber sub-strip 801 is configured to transmit the optical signal emitted by the second light transceiver assembly 500 to the outside of the optical module 200.

Correspondingly, an end of the fourth optical fiber sub-strip 802 is connected to the second light transceiver assembly 500, and another end of the fourth optical fiber sub-strip 802 is connected to the optical fiber adapter 210. The fourth optical fiber sub-strip 802 is configured to transmit the optical signal from the outside of the optical module 200 to the second light transceiver assembly 500.

The optical fiber adapter 210 is connected to the external optical fiber. The optical signals transmitted by the first optical fiber sub-strip 701 and the third optical fiber sub-strip 801 may be transmitted to the external optical fiber through the optical fiber adapter 210, so as to achieve the emission of the optical signal. The optical signal from the external optical fiber may be transmitted to the second optical fiber sub-strip 702 and the fourth optical fiber sub-strip 802 through the optical fiber adapter 210, so as to achieve the reception of the optical signal. It will be noted that the optical module 200 may also include two, three, or more optical fiber adapters 210, and the present disclosure is not limited thereto.

FIG. 8 is a partial exploded view of a circuit board, a circuit sub-board, a first light transceiver assembly, and a second light transceiver assembly in an optical module, in accordance with some embodiments. As shown in FIG. 8, when the first light transceiver assembly 400 is installed, the circuit sub-board 310 may be firstly attached to the circuit board 300, so that the first mounting region 360 of the circuit board 300 may be exposed through the connecting hole 330 of the circuit sub-board 310. Then the signal processing chip 320 is arranged on the circuit sub-board 310. Then the first light transceiver assembly 400 is embedded in the connecting hole 330, so that the first light transceiver assembly 400 may be installed on the first mounting region 360. Then the second light transceiver assembly 500 is installed on the second mounting region 370 of the circuit board 300.

After the first light transceiver assembly 400 and the second light transceiver assembly 500 are installed on the circuit board 300, the first light transceiver assembly 400 and the second light transceiver assembly 500 each are electrically connected, so that the first light transceiver assembly 400 and the second light transceiver assembly 500 may perform photoelectric conversion.

It will be noted that the installation order of the first light transceiver assembly 400 and the second light transceiver assembly 500 may be exchanged, and the present disclosure is not limited thereto.

In some embodiments, as shown in FIGS. 7 and 8, the first light transceiver assembly 400 includes a first light-emitting component 410 and a first silicon optical chip 420. The first light-emitting component 410 and the first silicon optical chip 420 each are embedded in the connecting hole 330 of the circuit sub-board 310, and the first silicon optical chip 420 is closer to the connecting finger 340 (or the signal processing chip 320) than the first light-emitting component 410. For example, the first light-emitting component 410 is located on a side of the first silicon optical chip 420 away from the connecting finger 340. The light beam emitted by the first light-emitting component 410 is transmitted into the first silicon optical chip 420, so as to perform the electrooptical modulation through the first silicon optical chip 420. That is to say, the first silicon optical chip 420 receives the light beam from the first light-emitting component 410.

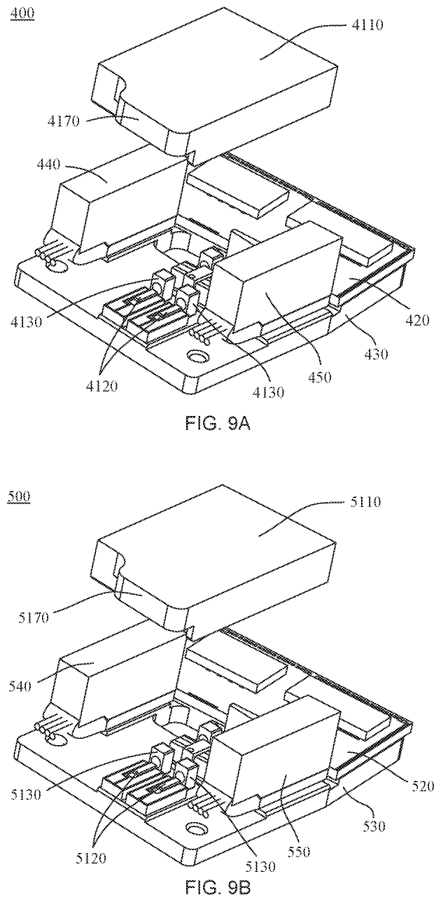

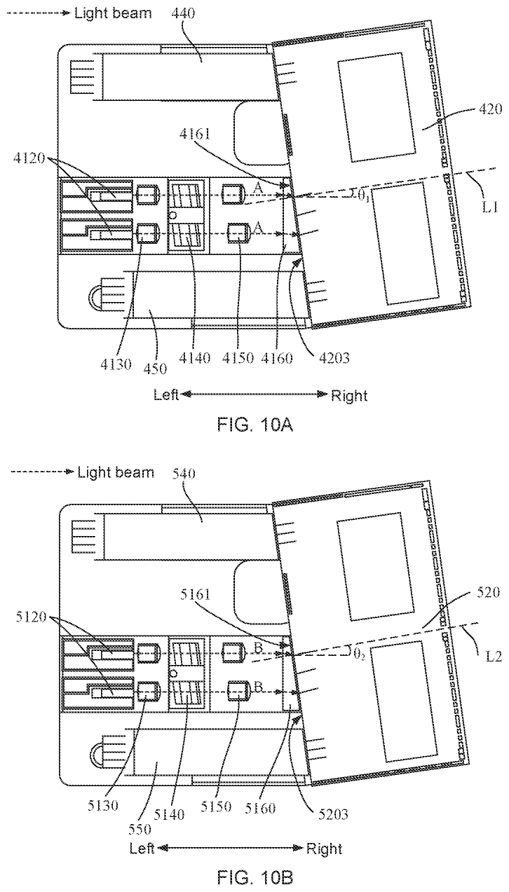

FIG. 9A is a partial exploded view of a first light transceiver assembly in an optical module, in accordance with some embodiments. FIG. 10A is a top view of a first light transceiver assembly in an optical module, in accordance with some embodiments. In some embodiments, as shown in FIGS. 9A and 10A, the first light transceiver assembly 400 further includes a first heat sink 430 embedded in the connecting hole 330, and a surface of the first heat sink 430 facing the circuit board 300 (e.g., a lower surface) is disposed on (e.g., attached to) the first mounting region 360 of the circuit board 300. The silicon optical chip 420 and the first light-emitting component 410 each are disposed on a surface of the first heat sink 430 away from the circuit board 300 (e.g., an upper surface).

Since the first silicon optical chip 420 is disposed on the first heat sink 430, the heat generated by the first silicon optical chip 420 may be conducted to the first heat sink 430 with high thermal conductivity, thereby improving the heat dissipation effect of the first silicon optical chip 420. For example, the first silicon optical chip 420 is attached to the first heat sink 430 through silver paste.

Moreover, the first heat sink 430 may also raise the first silicon optical chip 420, so that a surface of the first silicon optical chip 420 away from the first heat sink 430 and the surface of the circuit sub-board 310 away from the circuit board 300 are located on a same plane (e.g., a horizontal plane). In this way, pads of the first silicon optical chip 420 may be located at a same height as the upper surface of the circuit sub-board 310, so as to shorten lengths of connecting wires (e.g., golden wires) between the first silicon optical chip 420 and the circuit sub-board 310. Here, the same height does not mean that height values of the corresponding components are completely consistent, but there may be slight numerical errors.

It will be noted that the first heat sink 430 may also raise the first light-emitting component 410, so as to shorten lengths of connecting wires between the element in the first light-emitting component 410 and the circuit sub-board 310.

In some embodiments, as shown in FIGS. 9A and 10A, the first light transceiver assembly 400 further includes a first optical fiber connector 440 and a second optical fiber connector 450. The end of the first optical fiber sub-strip 701 is connected to the first optical fiber connector 440, and the end of the second optical fiber sub-strip 702 is connected to the second optical fiber connector 450. It will be noted that, some embodiments of the present disclosure are described by considering an example in which a silicon optical chip is connected to two optical fiber connectors, however, the present disclosure is not limited thereto. In some embodiments, a silicon optical chip may also be connected to one, three, or more fiber optic connectors.

In some embodiments, as shown in FIGS. 9A and 10A, the first light-emitting component 410 includes a first housing 4110, a first laser device 4120, a first collimating lens 4130, a first optical isolator 4140, and a first converging lens 4150. The first laser device 4120, the first collimating lens 4130, the first optical isolator 4140, and the first converging lens 4150 each are disposed on the first heat sink 430, and the first housing 4110 covers on the first heat sink 430, so that the first laser device 4120, the first collimating lens 4130, the first optical isolator 4140, and the first converging lens 4150 are located in a closed cavity formed between the first housing 4110 and the first heat sink 430.

The laser beam emitted by the first laser device 4120 is collimated into a collimated beam by the first collimating lens 4130, and the collimated beam passes through the first optical isolator 4140. In this way, the collimated beam passing through the first optical isolator 4140 is converged into a converged beam by the first converging lens 4150, and the converged beam is incident into the first silicon optical chip 420 and undergoes the electro-optic modulation within the first silicon optical chip 420.

In some embodiments, as shown in FIG. 10A, the first laser device 4120, the first collimating lens 4130, the first optical isolator 4140, and the first converging lens 4150 are sequentially arranged on the first heat sink 430 in the first direction (e.g., the left-right direction). The first silicon optical chip 420 is obliquely arranged relative to a laser-exit direction of the first laser device 4120. That is to say, a center line L1 of the first silicon optical chip 420 and a laser-exit direction A of the first light-emitting component 410 are arranged at a preset first angle θ₁.

In this way, when the light beam exiting from the first converging lens 4150 is reflected at an input surface 4203 of the first silicon optical chip 420, the reflected beam does not return to the first laser device 4120 along the original path. Moreover, when the reflected beam is incident on the first optical isolator 4140, the reflected beam is isolated by the first optical isolator 4140, so that the reflected beam may not return to the first laser device 4120, which may prevent the reflected beam from affecting the luminous performance of the first laser device 4120.

In some embodiments, the first angle θ₁ between the center line L1 of the first silicon optical chip 420 and the laser-exit direction A of the first light-emitting component 410 may be 8°.

In some embodiments, as shown in FIG. 10A, the first light-emitting component 410 further includes a first optical glass block 4160 located between the first converging lens 4150 and the input surface 4203 of the first silicon optical chip 420, and an output surface 4161 of the first optical glass block 4160 is in contact with the input surface 4203 of the first silicon optical chip 420. The first optical glass block 4160 may be in a shape of a wedge and configured to change a laser-exit angle of the laser beam, so that the laser beam emitted by the first laser device 4120 may enter the first silicon optical chip 420 obliquely arranged.

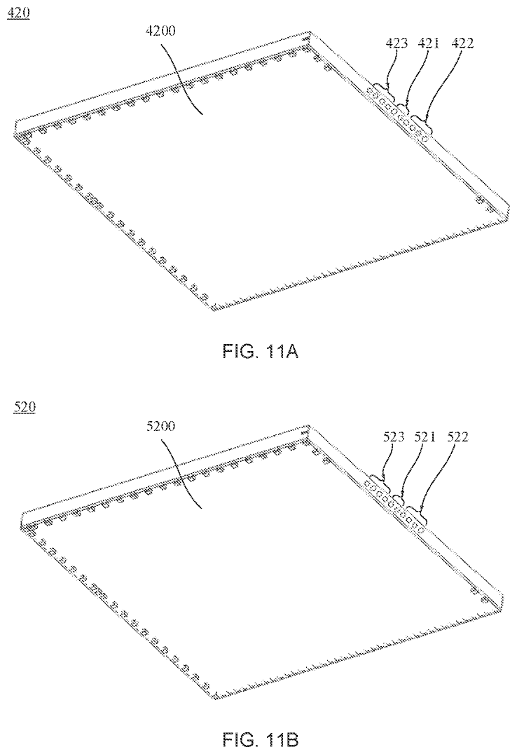

FIG. 11A is a diagram showing a structure of a first silicon optical chip in an optical module, in accordance with some embodiments. In some embodiments, as shown in FIG. 11A, the first silicon optical chip 420 further includes a first chip body 4200 and a first optical port 421, a second optical port 422, and a third optical port 423 that are disposed on the first chip body 4200. The first optical glass block 4160 is disposed corresponding to the first optical port 421, so that the laser beam with the changed laser-exit angle is incident into the first silicon optical chip 420 through the first optical port 421.

The third optical port 423 is connected to the first optical fiber sub-strip 701 through the first optical fiber connector 440. The first silicon optical chip 420 transmits the processed optical signal to the first optical fiber sub-strip 701 through the third optical port 423, so as to transmit the optical signal to the external optical fiber through the first optical fiber sub-strip 701 and the optical fiber adapter 210, thereby achieving the emission of the optical signal.

Correspondingly, the second optical port 422 is connected to the second optical fiber sub-strip 702 through the second optical fiber connector 450, and the external optical signal is transmitted into the first silicon optical chip 420 through the second optical fiber sub-strip 702 and the second optical port 422. The first silicon optical chip 420 converts the external optical signal into the electrical signal. The electrical signal is transmitted to the signal processing chip 320 through the circuit sub-board 310 and then transmitted to the circuit board 300 after being processed by the signal processing chip 320.

In some embodiments, as shown in FIG. 11A, the first optical port 421, the second optical port 422, and the third optical port 423 of the first silicon optical chip 420 are located on a same surface of the first chip body 4200. In this way, the first optical fiber connector 440 and the second optical fiber connector 450 that are connected to the first silicon optical chip 420 may be located on a same side of the first silicon optical chip 420, so that the first optical fiber sub-strip 701 and the second optical fiber sub-strip 702 each may be directly connected to the optical fiber adapter 210 and the first silicon optical chip 420, so as to avoid entanglement of optical fiber strips and reduce power consumption.

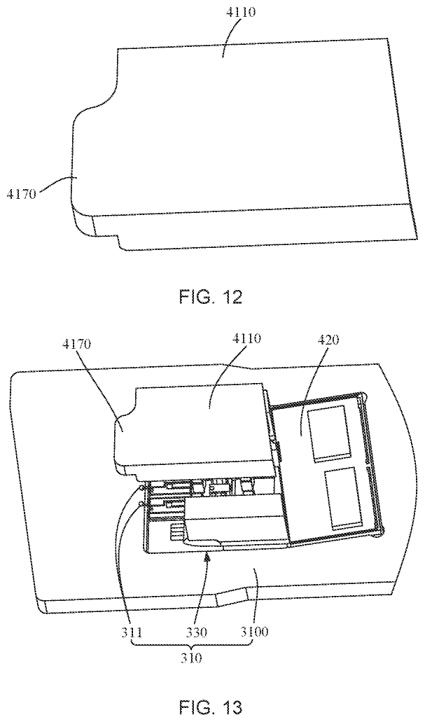

FIG. 12 is a diagram showing a structure of a first housing in an optical module, in accordance with some embodiments. FIG. 13 is a partial exploded view of a circuit sub-board and a first light transceiver assembly in an optical module, in accordance with some embodiments. As shown in FIGS. 12 and 13, the circuit sub-board 310 further includes a first pad 311 disposed at an edge of the connecting hole 330 away from the connecting finger 340. The first pad 311 is electrically connected to the first laser device 4120 through a connecting wire, so as to drive the first laser device 4120 to emit a laser beam.

In this case, the first housing 4110 includes a first protrusion 4170. The first protrusion 4170 is provided by at least a portion of an end of the first housing 4110 away from the first silicon optical chip 420 protruding in a direction away from the first silicon optical chip 420. The first protrusion 4170 is located outside the connecting hole 330 and is in contact with the surface of the circuit sub-board 310 facing away from the circuit board 300, so that the first pad 311 and the connecting wire corresponding to the first pad 311 may be covered in the first housing 4110 through the first protrusion 4170. As a result, the connecting wire may be protected, and it may be possible to prevent the connecting wire from generating electromagnetic interference (EMI) to the outside.

In some embodiments, after the first laser device 4120, the first collimating lens 4130, the first optical isolator 4140, the first converging lens 4150, the first optical glass block 4160, and the first silicon optical chip 420 are fixed on the first heat sink 430, the assembled first heat sink 430 is installed on the first mounting region 360 of the circuit board 300 through the connecting hole 330. Then the first laser device 4120 is connected to the first pad 311 of the circuit sub-board 310 through the connecting wire. Finally, the first housing 4110 is covered on the first heat sink 430, so as to cover the first laser device 4120, the first collimating lens 4130, the first optical isolator 4140, the first converging lens 4150, the first optical glass block 4160, and the connecting wire corresponding to the first pad 311 in the first housing 4110.

In some embodiments, the structure of the second light transceiver assembly 500 is similar to that of the first light transceiver assembly 400. Here, the second light transceiver assembly 500 is similar to the first light transceiver assembly 400, which may be understood that the two have a same conception, but the specific structures may be same or different from each other. The structure of the second light transceiver assembly 500 will be introduced below.

As shown in FIG. 8, the second light transceiver assembly 500 includes a second light-emitting component 510 and a second silicon optical chip 520 that are disposed on the second mounting region 370 of the circuit board 300. The second light-emitting component 510 is further away from the connecting finger 340 than the second silicon optical chip 520, and the light beam emitted by the second light-emitting component 510 is transmitted into the second silicon optical chip 520, so as to perform the electro-optic modulation through the second silicon optical chip 520. That is to say, the second silicon optical chip 520 receives the light beam from the second light-emitting component 510.

FIG. 9B is a partial exploded view of a second light transceiver assembly in an optical module, in accordance with some embodiments. FIG. 10B is a top view of a second light transceiver assembly in an optical module, in accordance with some embodiments. In some embodiments, as shown in FIGS. 9B and 10B, the second light transceiver assembly 500 further includes a second heat sink 530. A surface of the second heat sink 530 facing the circuit board 300 (e.g., a lower surface) is disposed on (e.g., attached to) the second mounting region 370 of the circuit board 300, and the second light-emitting component 510 and the second silicon optical chip 520 each are disposed on a surface of the second heat sink 530 away from the circuit board 300 (e.g., an upper surface).

Since the second silicon optical chip 520 is disposed on the second heat sink 530, the heat generated by the second silicon optical chip 520 may be conducted to the second heat sink 530 with high thermal conductivity, thereby improving the heat dissipation effect of the second silicon optical chip 520.

Moreover, the second heat sink 530 may also raise the second silicon optical chip 520, so that a surface of the second silicon optical chip 520 facing away from the second heat sink 530 and the surface of the circuit sub-board 310 facing away from the circuit board 300 are located on a same plane (e.g., a horizontal plane). In this way, pads of the second silicon optical chip 520 may be at the same height as the upper surface of the circuit sub-board 310, so as to shorten lengths of connecting wires between the second light transceiver assembly 500 and the circuit sub-board 310.

It will be noted that the second heat sink 530 may also raise the second light-emitting component 510, so as to shorten lengths of connecting wires between the component in the second light-emitting component 510 and the circuit sub-board 310.

In some embodiments, as shown in FIGS. 9B and 10B, the second light transceiver assembly 500 further includes a third optical fiber connector 540 and a fourth optical fiber connector 550. The end of the third optical fiber sub-strip 801 is connected to the third optical fiber connector 540, and the end of the fourth optical fiber sub-strip 802 is connected to the fourth optical fiber connector 550.

In some embodiments, the structure of the second light-emitting component 510 is similar to that of the first light-emitting component 410, and the structure of the second silicon optical chip 520 is similar to that of the first silicon optical chip 420.

As shown in FIGS. 9B and 10B, the second light-emitting component 510 includes a second housing 5110, a second laser device 5120, a second collimating lens 5130, a second optical isolator 5140, and a second converging lens 5150. The second laser device 5120, the second collimating lens 5130, the second optical isolator 5140, and the second converging lens 5150 each are disposed on the second heat sink 530, and the second housing 5110 covers on the second heat sink 530, so that the second laser device 5120, the second collimating lens 5130, the second optical isolator 5140, and the second converging lens 5150 are located in a closed cavity formed between the second housing 5110 and the second heat sink 530.

The laser beam emitted by the second laser device 5120 is collimated into a collimated beam by the second collimating lens 5130, and the collimated beam passes through the second optical isolator 5140. The collimated beam passing through the second optical isolator 5140 is converged into a converged beam by the second converging lens 5150. The converged beam is incident into the second silicon optical chip 520 and undergoes the electro-optic modulation within the second silicon optical chip 520.

In some embodiments, as shown in FIG. 10B, the second laser device 5120, the second collimating lens 5130, the second optical isolator 5140, and the second converging lens 5150 are sequentially arranged on the second heat sink 530 in the first direction. The second silicon optical chip 520 is obliquely arranged relative to a laser-exit direction of the second laser device 5120. That is to say, a center line L2 of the second silicon optical chip 520 and a laser-exit direction B of the second light-emitting component 510 are arranged at a preset second angle 12.

In this way, when the light beam exiting from the second converging lens 5150 is reflected at an input surface 5203 of the second silicon optical chip 520, the reflected beam does not return to the second laser device 5120 along the original path. Moreover, when the reflected beam is incident on the second optical isolator 5140, the reflected beam is isolated by the second optical isolator 5140, so that the reflected beam may not return to the second laser device 5120, which may prevent the reflected beam from affecting the luminous performance of the second laser device 5120.

In some embodiments, the second angle 82 between the center line L2 of the second silicon optical chip 520 and the laser-exit direction B of the second light-emitting component 510 may be 8°.

In some embodiments, as shown in FIG. 10B, the second light-emitting component 510 further includes a second optical glass block 5160 located between the second converging lens 5150 and the input surface 5203 of the second silicon optical chip 520, and an output surface 5161 of the second optical glass block 5160 is in contact with the input surface 5203 of the second silicon optical chip 520. The second optical glass block 5160 may be in a shape of a wedge and configured to change a laser-exit angle of the laser beam, so that the laser beam emitted by the second laser device 5120 may enter the second silicon optical chip 520 obliquely arranged.

It will be noted that the first light transceiver assembly 400 and the second light transceiver assembly 500 each may also include a plurality of laser devices and optical components corresponding to the laser devices, and the present disclosure is not limited thereto.

FIG. 11B is a diagram showing a structure of a second silicon optical chip in an optical module, in accordance with some embodiments. In some embodiments, as shown in FIG. 11B, the second silicon optical chip 520 further includes a second chip body 5200 and a fourth optical port 521, a fifth optical port 522, and a sixth optical port 523 that are disposed on the second chip body 5200. The second optical glass block 5160 is disposed corresponding to the fourth optical port 521, so that the laser beam with the changed laser-exit angle is incident into the second silicon optical chip 520 through the fourth optical port 521.

The sixth optical port 523 is connected to the third optical fiber sub-strip 801 through the third optical fiber connector 540. The second silicon optical chip 520 transmits the processed optical signal to the third optical fiber sub-strip 801 through the sixth optical port 523, so as to transmit the optical signal to the external optical fiber through the third optical fiber sub-strip 801 and the optical fiber adapter 210, thereby achieving the emission of the optical signal.

Correspondingly, the fifth optical port 522 is connected to the fourth optical fiber sub-strip 802 through the fourth optical fiber connector 550, and the external optical signal is transmitted into the second silicon optical chip 520 through the fourth optical fiber sub-strip 802 and the fifth optical port 522. The second silicon optical chip 520 converts the external optical signal into the electrical signal. The electrical signal is transmitted to the signal processing chip 320 through the circuit sub-board 310 and then transmitted to the circuit board 300 after being processed by the signal processing chip 320.

In some embodiments, as shown in FIG. 11B, the fourth optical port 521, the fifth optical port 522, and the sixth optical port 523 of the second silicon optical chip 520 are located on a same surface of the second chip body 5200. In this way, the third optical fiber connector 540 and the fourth optical fiber connector 550 that are connected to the second silicon optical chip 520 may be located on a same side of the second silicon optical chip 520, so that the third optical fiber sub-strip 801 and the fourth optical fiber sub-strip 802 each may be directly connected to the optical fiber adapter 210 and the second silicon optical chip 520, so as to avoid entanglement of the optical fiber strips and reduce power consumption.

In some embodiments, as shown in FIG. 5, the circuit board 300 includes a second body 3000 and a second pad 304 disposed at a position of the second body 3000 proximate to the second laser device 5120. The second pad 304 is electrically connected to the second laser device 5120 through a connecting wire, so as to drive the second laser device 5120 to emit a laser beam. It will be noted that the position of the second pad 304 in FIG. 5 is only an example.

In this case, as shown in FIG. 9B, the second housing 5110 includes a second protrusion 5170. The second protrusion 5170 is provided by at least a portion of an end of the second housing 5110 away from the second silicon optical chip 520 protruding in a direction away from the second silicon optical chip 520. The second protrusion 5170 covers the second pad 304 and the connecting wire corresponding to the second pad 304, so as to protect the connecting wire between the second laser device 5120 and the circuit board 300.

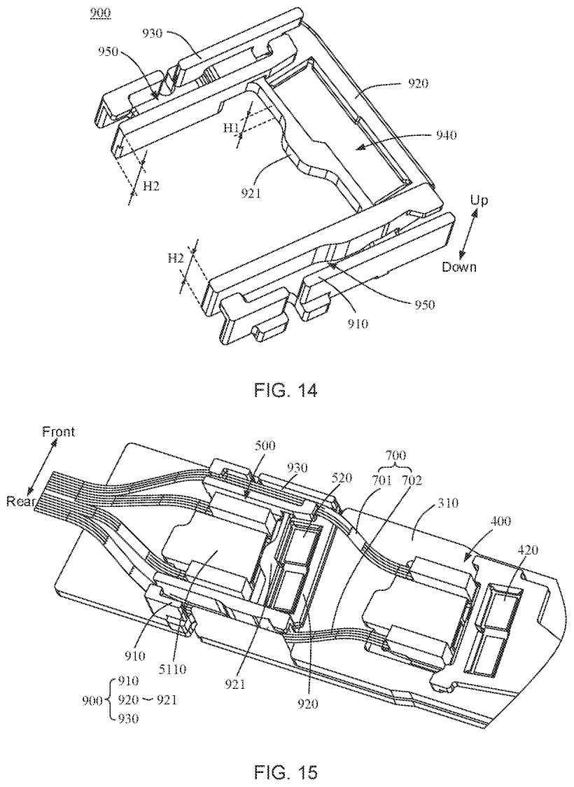

FIG. 14 is a diagram showing a structure of a fixing frame in an optical module, in accordance with some embodiments. FIG. 15 is a diagram showing partial structures of a circuit board, a first light transceiver assembly, a second light transceiver assembly, a first optical fiber strip, and a second optical fiber strip in an optical module, in accordance with some embodiments.

In some embodiments, as shown in FIGS. 14 and 15, the optical module 200 further includes a fixing frame 900 disposed on the circuit board 300 and located outside the second light transceiver assembly 500. The first optical fiber sub-strip 701 and the second optical fiber sub-strip 702 that are connected to the first light transceiver assembly 400 are fixed on the circuit board 300 through the fixing frame 900.

For example, the fixing frame 900 includes a first fixing plate 910, a second fixing plate 920, and a third fixing plate 930. Two ends of the second fixing plate 920 are connected with the first fixing plate 910 and the third fixing plate 930, respectively, and the first fixing plate 910 and the third fixing plate 930 are arranged opposite to each other in a width direction (e.g., the front-rear direction in FIG. 15) of the circuit board 300, so that the first fixing plate 910, the second fixing plate 920, and the third fixing plate 930 may form a fixing frame with a shape of a letter “U”.

The first fixing plate 910 and the third fixing plate 930 are located outside the second light transceiver assembly 500, and the second fixing plate 920 is located on a side (e.g., an upper side) of the second silicon optical chip 520 away from the circuit board 300, so that at least a portion of the second light transceiver assembly 500 may be surrounded by the fixing frame 900.

In some embodiments, after the fixing frame 900 is fixed on the circuit board 300, the first optical fiber sub-strip 701 connected to the first light transceiver assembly 400 is fixed on the third fixing plate 930, and the second optical fiber sub-strip 702 connected to the first light transceiver assembly 400 is fixed on the first fixing plate 910, so as to achieve the fixation of the first optical fiber sub-strip 701 and the second optical fiber sub-strip 702 on the circuit board 300. In this way, by arranging the fixing frame 900 to fix the first optical fiber sub-strip 701 and the second optical fiber sub-strip 702, the first optical fiber sub-strip 701 and the second optical fiber sub-strip 702 may be regularly arranged.

For example, as shown in FIG. 14, the fixing frame 900 further includes two mounting grooves 950 disposed on the first fixing plate 910 and the third fixing plate 930, respectively. The first optical fiber sub-strip 701 and the second optical fiber sub-strip 702 are installed in the two mounting grooves 950, respectively.

In some embodiments, as shown in FIG. 14, a dimension H1 of the second fixing plate 920 in the thickness direction (e.g., the up-down direction) of the circuit board 300 is less than dimensions H2 of the first fixing plate 910 and the third fixing plate 930 in the thickness direction of the circuit board 300. In this way, in a case where the first fixing plate 910 and the third fixing plate 930 are fixed on the circuit board 300, the second fixing plate 920 may cover on the second silicon optical chip 520, so as to cover the pads of the second silicon optical chip 520 and the corresponding connecting wires, thereby protecting the connecting wires connecting the second silicon optical chip 520 with the circuit sub-board 310.

It will be understood that the dimensions of the first fixing plate 910 and the third fixing plate 930 may be equal or unequal to each other in the thickness direction of the circuit board 300, and the present disclosure is not limited thereto.

In some embodiments, as shown in FIG. 14, the fixing frame 900 further includes a through hole 940. The through hole 940 is disposed on the second fixing plate 920 and runs through an upper surface and a lower surface of the second fixing plate 920 in a thickness direction (e.g., the up-down direction) of the second fixing plate 920. In this way, after the second fixing plate 920 is disposed on the second silicon optical chip 520, a portion of the second silicon optical chip 520 may be exposed through the through hole 940, so as to facilitate heat dissipation of the second silicon optical chip 520.

In some embodiments, as shown in FIG. 14, the second fixing plate 920 includes a third protrusion 921. An end of the second fixing plate 920 facing the second housing 5110 protrudes toward the second light transceiver assembly 500, so as to form the third protrusion 921. The third protrusion 921 is in contact with an end of the second housing 5110, so as to limit the second housing 5110. In this case, the movement of the second housing 5110 in a direction proximate to the first light transceiver assembly 400 (e.g., from left to right) may be limited through the third protrusion 921.

After the first light transceiver assembly 400 and the second light transceiver assembly 500 are disposed on the circuit board 300, by providing one signal processing chip 320, the high frequency signal may be transmitted from the circuit board 300 to the first light transceiver assembly 400 and the second light transceiver assembly 500, and the first light transceiver assembly 400 and the second light transceiver assembly 500 may work normally.

However, the present disclosure is not limited thereto. In some embodiments, the optical module 200 may include a plurality of signal processing chips 320, a plurality of circuit sub-boards 310, and a plurality of light transceiver assemblies. The plurality of signal processing chips 320 are disposed on the plurality of circuit sub-boards 310 respectively, and the plurality of light transceiver assemblies correspond to the plurality of circuit sub-boards 310, respectively. One light transceiver assembly is located at an end of the corresponding circuit sub-board 310 away from the connecting finger 340 of the circuit board 300 and located in the connecting hole 330 of the corresponding circuit sub-board 310.

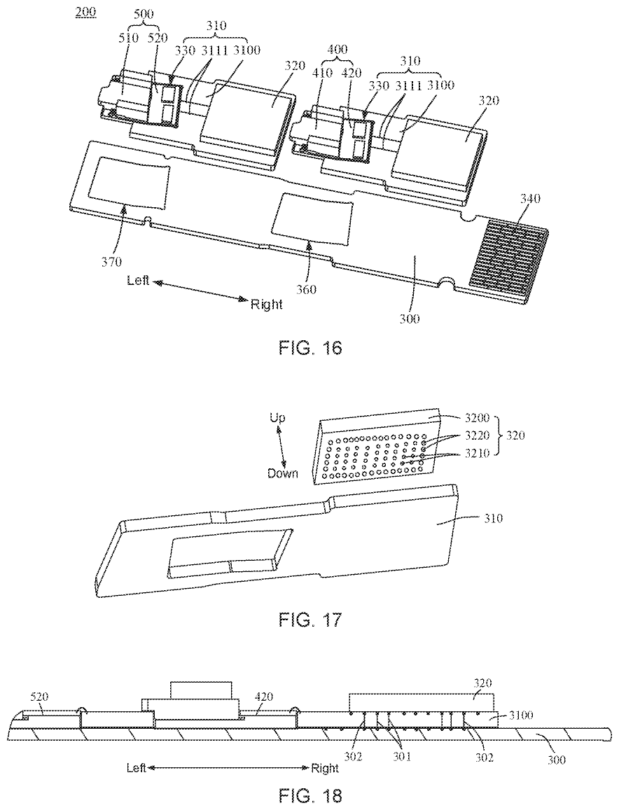

FIG. 16 is a diagram showing a partial structure of another optical module, in accordance with some embodiments. In some examples, as shown in FIG. 16, the optical module 200 includes two signal processing chips 320 and two circuit sub-boards 310. The two circuit sub-boards 310 are disposed on the circuit board 300 and may be arranged in the first direction. The first light transceiver assembly 400 and the second light transceiver assembly 500 are disposed on the circuit board 300 and are located in the connecting holes 330 of the two circuit sub-boards 310, respectively, and are connected to the two circuit sub-boards 310, respectively. The two signal processing chips 320 each are disposed on the surface of the corresponding circuit sub-board 310 away from the circuit board 300. The two signal processing chips 320 are electrically connected to the silicon optical chips in the first light transceiver assembly 400 and the second light transceiver assembly 500 through corresponding signal line, so as to transmit the electrical signals to the silicon optical chips or receive the electrical signals from the silicon optical chips.

For example, as shown in FIG. 16, the circuit sub-board 310 includes a signal line 3111. An end of the signal line 3111 is located at an edge of the connecting hole 330 proximate to the signal processing chip 320 and electrically connected to the corresponding light transceiver assembly, and another end of the signal line 3111 is electrically connected to the corresponding signal processing chip 320.

The following is mainly described by considering an example in which the optical module 200 includes one signal processing chip 320; however, this cannot be understood as a limitation of the present disclosure.

FIG. 17 is an exploded view of a circuit sub-board and a signal processing chip in an optical module, in accordance with some embodiments. FIG. 18 is a sectional view of a circuit board, a circuit sub-board, and a signal processing chip in an optical module, in accordance with some embodiments.

In some embodiments, as shown in FIGS. 17 and 18, the signal processing chip 320 is disposed on the circuit sub-board 310. The electrical signal transmitted by the connecting finger 340 of the circuit board 300 is transmitted to the signal processing chip 320 by the circuit sub-board 310, and the electrical signal processed by the signal processing chip 320 is transmitted to the first light transceiver assembly 400 through the corresponding signal line (e.g., the first signal line 3101 in FIG. 21), so that the first light transceiver assembly 400 may emit the optical signal. After being transmitted to the first light transceiver assembly 400, the external optical signal is converted into the electrical signal by the first silicon optical chip 420. The electrical signal is transmitted to the signal processing chip 320 through the corresponding signal line. The electrical signal processed by the signal processing chip 320 is transmitted to the connecting finger 340 of the circuit board 300 by the circuit sub-board 310, thereby achieving the reception of the optical signal.

For example, as shown in FIGS. 17 and 18, the signal processing chip 320 includes a third body 3200 and first solder balls 3210 (i.e., signal solder balls). The first solder balls 3210 are disposed on a surface of the third body 3200 proximate to the circuit sub-board 310 (e.g., a lower surface), and the first solder balls 3210 are designed in the form of a ball grid array (BGA) encapsulation. In a case where the signal processing chip 320 is disposed on the circuit sub-board 310, the first solder balls 3210 of the signal processing chip 320 are connected to the upper surface of the circuit sub-board 310, so as to achieve the electrical connection between the signal processing chip 320 and the circuit sub-board 310.

The signal processing chip 320 further includes grounding solder balls 3220, and the grounding solder balls 3220 are disposed on the surface of the third body 3200 proximate to the circuit sub-board 310 and located on an outer periphery of the first solder balls 3210. That is to say, the grounding solder balls 3220 are arranged around the first solder balls 3210. The grounding solder balls 3220 are grounded. In this way, by providing the grounding solder balls 3220, it is possible to increase a return path of the signal and reduce electromagnetic interference.

In some embodiments, the circuit sub-board 310 further includes second solder balls disposed on the surface of the first body 3100 proximate to the circuit board 300 (e.g., the lower surface). In a case where the circuit sub-board 310 is disposed on the circuit board 300, the second solder balls of the circuit sub-board 310 are connected to the upper surface of the circuit board 300, so as to achieve the electrical connection between the circuit sub-board 310 and the circuit board 300.

For example, pads are arranged at positions of the circuit board 300 corresponding to the circuit sub-board 310, and the second solder balls of the circuit sub-board 310 are connected to the pads on the circuit board 300 by soldering tin, so that the circuit sub-board 310 may be attached to the circuit board 300.

The circuit sub-board 310 further includes third signal lines 301 disposed inside the first body 3100. An end of the third signal line 301 is connected to the first solder ball 3210 of the signal processing chip 320, and another end of the third signal line 301 is connected to the pad on the circuit board 300. In this way, the electrical signal of the circuit board 300 may be transmitted to the signal processing chip 320 through the third signal line 301 or the electrical signal processed by the signal processing chip 320 may be transmitted to the circuit board 300 through the third signal line 301, so as to achieve the transmission of the electrical signal between the circuit board 300 and the signal processing chip 320.

In this case, the circuit board 300 further includes a fourth signal line disposed on a surface (e.g., an upper surface) of the second body 3000. An end of the fourth signal line is connected to the connecting finger 340, and another end (e.g., the pad on the circuit board 300) is connected to the third signal line 301 of the circuit sub-board 310. That is to say, the end of the third signal line 301 in the circuit sub-board 310 is connected to the signal processing chip 320, and the another end of the third signal line 301 is connected to the fourth signal line on the circuit board 300, so that the electrical signal of the circuit board 300 may be transmitted to the signal processing chip 320, or the electrical signal processed by the signal processing chip 320 may be transmitted to the circuit board 300.

It will be noted that the another end of the third signal line 301 may be connected to the pad on the circuit board 300 through the second solder ball. The another end of the fourth signal line may be connected to the third signal line 301 through the pad on the circuit board 300.

In some embodiments, as shown in FIG. 18, the circuit sub-board 310 further includes one or more grounding signal lines 302. The grounding signal line 302 is disposed inside the first body 3100. An end of the grounding signal line 302 is connected to the grounding solder ball 3220 of the signal processing chip 320, and another end of the grounding signal line 302 is connected to the corresponding grounding pad on the circuit board 300, so as to achieve the grounding connection of the signal processing chip 320 through the grounding signal line 302.

In some embodiments, the grounding signal line 302 is located outside of the third signal lines 301. For example, as shown in FIG. 18, the plurality of grounding signal lines 302 are disposed at positions of the circuit sub-board 310 corresponding to the left and right sides of the signal processing chip 320, and the third signal lines 301 are disposed between the grounding signal lines 302 on the left and right sides. In this way, the grounding signal lines 302 and the third signal lines 301 may form at least one return path, so as to reduce the external electromagnetic radiation of the third signal line 301 and external interference.

In some embodiments, in a case where the signal processing chip 320 is electrically connected to the circuit board 300, in addition to providing the grounding solder balls 3220 and the grounding signal lines 302, it is also possible to provide grounding via holes on the circuit sub-board 310, so as to add the return path of the signal through the grounding via holes, thereby avoiding external interference.

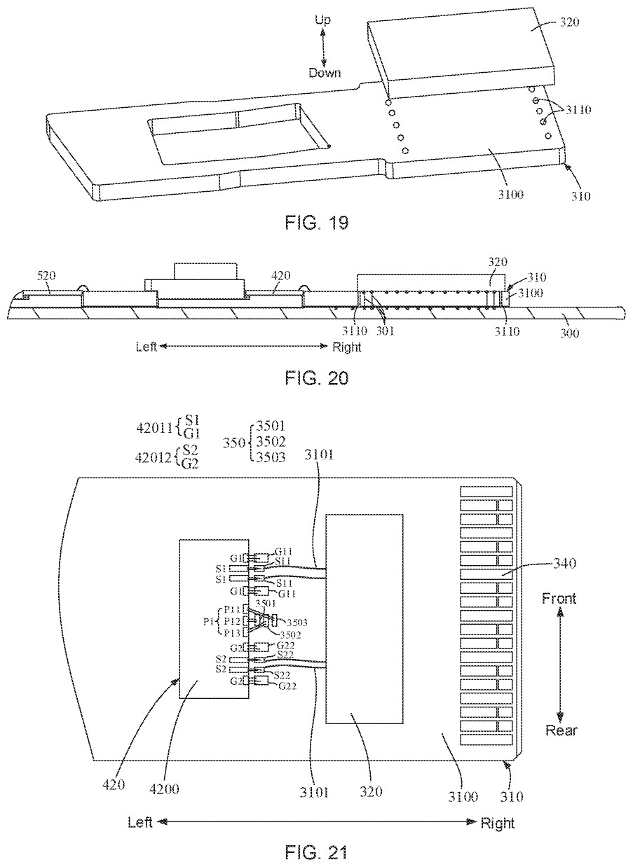

FIG. 19 is another exploded view of a circuit sub-board and a signal processing chip in an optical module, in accordance with some embodiments. FIG. 20 is another sectional view of a circuit board, a circuit sub-board, and a signal processing chip in an optical module, in accordance with some embodiments. As shown in FIGS. 19 and 20, the circuit sub-board 310 includes one or more grounding via holes 3110. The grounding via hole 3110 runs through the upper surface and the lower surface of the first body 3100 in the thickness direction of the circuit sub-board 310, and an end of the grounding via hole 3110 is connected to the grounding solder ball 3220 of the signal processing chip 320, and another end of the grounding via hole 3110 is connected to the corresponding grounding pad of the circuit board 300. The grounding via hole 3110 may be filled with a conductive medium (e.g., copper). In this way, the grounding connection between the signal processing chip 320 and the circuit board 300 may be achieved through the grounding via holes 3110.

In some embodiments, the grounding via holes 3110 are disposed outside the third signal lines 301. For example, as shown in FIG. 20, the plurality of grounding via holes 3110 are disposed at positions of the circuit sub-board 310 corresponding to the left and right sides of the signal processing chip 320, and the third signal lines 301 are disposed between the grounding via holes 3110 on the two sides. The grounding via holes 3110 may be provided proximate to the third signal lines 301, so that at least one return path may be provided between the grounding via holes 3110 and the third signal lines 301.

After the circuit board 300 is connected with the signal processing chip 320 through the third signal lines 301 and the grounding signal lines 302 or the grounding via holes 3110, the signal processing chip 320 may be electrically connected to the first silicon optical chip 420 and the second silicon optical chip 520 through the plurality of signal lines (e.g., the first signal line 3101 in FIG. 21 and the second signal line 312 in FIG. 23) arranged on the surface of the circuit sub-board 310 facing away from the circuit board 300, so as to drive the first silicon optical chip 420 and the second silicon optical chip 520 to process the transmitting optical signals and the receiving optical signals.

FIG. 21 is a diagram showing partial structures of a first silicon optical chip and a signal processing chip in an optical module, in accordance with some embodiments. FIG. 21 shows the connection relationship between the first silicon optical chip 420 and the signal processing chip 320.

In some embodiments, as shown in FIG. 21, a high frequency signal line is arranged on the surface of the circuit sub-board 310. An end of the high frequency signal line is located at the edge of the connecting hole 330 proximate to the signal processing chip 320, and another end of the high frequency signal line is connected to the signal processing chip 320. The first silicon optical chip 420 is connected to the high frequency signal line at the edge of the connecting hole 330 through the connecting wires, so that the electrical signal output by the signal processing chip 320 may be transmitted to the first silicon optical chip 420, or the electrical signal processed by the first silicon optical chip 420 may be transmitted to the signal processing chip 320.

In some examples, as shown in FIG. 21, the first silicon optical chip 420 further includes a first pad group 42011, a second pad group 42012, and a first power signal pad P1. The first pad group 42011, the second pad group 42012, and the first power signal pad P1 are arranged on a surface of the first chip body 4200 facing away from the circuit board 300 (e.g., an upper surface) and proximate to the signal processing chip 320. The first silicon optical chip 420 transmits the electrical signal to the signal processing chip 320 through the first pad group 42011, and the first silicon optical chip 420 receives the electrical signal from the signal processing chip 320 through the second pad group 42012. The first power signal pad P1 is disposed between the first pad group 42011 and the second pad group 42012, so as to reduce the interference of the transmitting signal to the receiving signal.

The first pad group 42011 includes a first transmitting signal pad S1 and a first grounding signal pad G1. The first grounding signal pad G1 is disposed on at least one side of two sides of the first transmitting signal pad S1 in the width direction of the circuit board 300. The circuit sub-board 310 further includes one or more first transmitting pads S11 (i.e., third pads), a first grounding pad G11, and a plurality of first signal lines 3101. The first transmitting pad S11 and the first grounding pad G11 are disposed on the edge of the connecting hole 330 proximate to the signal processing chip 320. The first transmitting pad S11 corresponds to the first transmitting signal pad S1, and the first grounding pad G11 corresponds to the first grounding signal pad G1.

For example, the first transmitting pad S11 is electrically connected to the first transmitting signal pad S1 through two connecting wires, and the first grounding pad G11 is electrically connected to the first grounding signal pad G1 through three connecting wires, thereby forming the return path. The plurality of first signal lines 3101 are disposed on the first body 3100, and the plurality of first signal lines 3101 include a first portion and a second portion. An end of a first portion of the plurality of first signal lines 3101 is located at the edge of the connecting hole 330 proximate to the signal processing chip 320 and connected to the first transmitting pad S11, and another end of the first portion of the plurality of first signal lines 3101 is connected to the signal processing chip 320. In this way, the electrical connection between the signal processing chip 320 and the first silicon optical chip 420 may be achieved through the first portion of the plurality of first signal lines 3101, the first transmit pad S11, the connecting wires, and the first transmit signal pad S1.

Similarly, the second pad group 42012 includes a first receiving signal pad S2 and a second grounding signal pad G2. The second grounding signal pad G2 is disposed on at least one side of the first receiving signal pad S2 in the width direction of the circuit board 300. The circuit board 310 further includes one or more first receiving pads S22 (i.e., fourth pads) and a second grounding pad G22. The first receiving pad S22 and the second grounding pad G22 are disposed on the edge of the connecting hole 330 proximate to the signal processing chip 320. The first receiving pad S22 corresponds to the first receiving signal pad S2, and the second grounding pad G22 corresponds to the second grounding signal pad G2.

For example, the first receiving signal pad S2 is electrically connected to the first receiving pad S22 through two connecting wires, and the second grounding signal pad G2 is electrically connected to the second grounding pad G22 through three connecting wires, thereby forming the return path. An end of a second portion of the plurality of first signal lines 3101 is located at the edge of the connecting hole 330 proximate to the signal processing chip 320 and connected to the first receiving pad S22, and another end of the second portion of the plurality of first signal lines 3101 is connected to the signal processing chip 320. In this way, the electrical connection between the signal processing chip 320 and the first silicon optical chip 420 may be achieved through the second portion of the plurality of first signal lines 3101, the first receiving pad S22, the connecting wires, and the first receiving signal pad S2.

In some embodiments, as shown in FIG. 21, the first silicon optical chip 420 includes at least three first power signal pads P1 arranged side by side in a second direction (e.g., the front-rear direction). The circuit sub-board 310 further includes at least three first power pads 350. The at least three first power pads 350 are disposed on the edge of the connecting hole 330 proximate to the signal processing chip 320, and the at least three first power pads 350 are arranged side by side in the first direction. The first direction is perpendicular to the second direction. That is to say, an arrangement direction of the plurality of first power signal pads P1 is perpendicular to an arrangement direction of the plurality of first power pads 350.

The following is described by considering an example in which the first silicon optical chip 420 includes three first power signal pads P1 and the circuit sub-board 310 includes three first power pads 350.

One first power signal pad located in the middle in the three first power signal pads P1 is connected to a first power pad 350 of the three first power pads 350 most proximate to the one first power signal pad through at least two connecting wires, and the other two first power signal pads P1 each are connected to the corresponding first power pad 350 through at least two connecting wires.

For example, as shown in FIG. 21, the first power signal pad P1 located in the middle in the three first power signal pads P1 is electrically connected to the first power pad 350 located on the left side in the three first power pads 350 through two connecting wires. The first power signal pad P1 located on the rear side in the three first power signal pads P1 is electrically connected to the first power pad 350 located in the middle in the three first power pads 350 through two connecting wires. The first power signal pad P1 located on the front side of the three first power signal pads P1 is electrically connected to the first power pad 350 located on the right side in the three first power pads 350 through two connecting wires.

For example, as shown in FIG. 21, the first silicon optical chip 420 includes a first power signal sub-pad P11, a second power signal sub-pad P12, and a third power signal sub-pad P13 that are arranged side by side in the front-rear direction, and the second power signal sub-pad P12 is located between the first power signal sub-pad P11 and the third power signal sub-pad P13. The circuit sub-board 310 includes a first sub-pad 3501, a second sub-pad 3502, and a third sub-pad 3503 that are arranged side by side in the left-right direction, and the second sub-pad 3502 is located between the first sub-pad 3501 and the third sub-pad 3503.

The first power signal sub-pad P11 is connected to the third sub-pad 3503 through the connecting wires, the second power signal sub-pad P12 is connected to the first sub-pad 3501 through the connecting wires, and the third power signal sub-pad P13 is connected to the second sub-pad 3502 through the connecting wires.

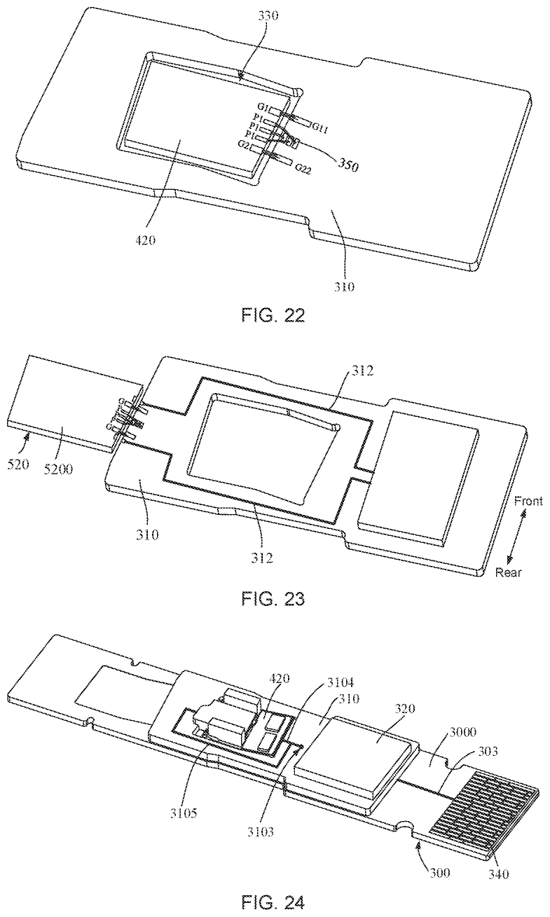

FIG. 22 is a diagram showing partial structures of a first silicon optical chip and a circuit sub-board in an optical module, in accordance with some embodiments. As shown in FIG. 22, the three first power signal pads P1 are disposed between the first grounding signal pad G1 of the first pad group 42011 and the second grounding signal pad G2 of the second pad group 42012, the three first power pads 350 are disposed between the first grounding pad G11 and the second grounding pad G22, and dimensions of the first grounding pad G11 and the second grounding pad G22 in the first direction each are greater than a dimension of the first power pad 350 in the first direction. It will be noted that the dimensions of the first grounding pad G11 and the second grounding pad G22 in the first direction may be same or different from each other.

In some embodiments, the plurality of first power pads 350 are sequentially arranged in the first direction, and an arrangement direction of the plurality of first power pads 350 may be different from an arrangement direction of the plurality of first power signal pads P1. In this way, the connecting wires between the plurality of first power pads 350 and the plurality of first power signal pads P1 may be spatially interlaced and form interlaced return paths with the grounding circuits on the two sides of the plurality of first power pads 350, thereby avoiding the signal crosstalk between the transmitting signal and the receiving signal.

The first silicon optical chip 420 is electrically connected to the connecting finger 340 of the circuit board 300 through the first power signal pad P1, the connecting wires, the first power pad 350, and the corresponding power line. As a result, the power signal from the connecting finger 340 is transmitted to the circuit sub-board 310 through the power line and then transmitted to the edge of the connecting hole 330 through an inner layer and a surface layer of the circuit sub-board 310, so as to supply power to the first silicon optical chip 420 through the first power pad 350, the connecting wires, and the first power signal pad P1, so that the first silicon optical chip 420 may receive the laser beam or the external optical signal.

The first silicon optical chip 420 is electrically connected to the signal processing chip 320 through the first pad group 42011, the second pad group 42012, the connecting wires, the first transmitting pad S11, the first receiving pad S22, and the first signal lines 3101. In this way, the electrical signal output by the signal processing chip 320 may be transmitted to the first silicon optical chip 420 through the first portion of the plurality of first signal lines 3101, the first transmitting pad S11, the connecting wires, and the first pad group 42011, so as to provide the electrical signal to the first silicon optical chip 420, so that the first silicon optical chip 420 may perform optical modulation on the laser beam according to the electrical signal, and the modulated optical signal is transmitted to the external optical fiber through the first optical fiber sub-strip 701. After the external optical signal is transmitted to the first silicon optical chip 420 through the second optical fiber sub-strip 702, the first silicon optical chip 420 processes the external optical signal into the electrical signal. The processed electrical signal is transmitted to the signal processing chip 320 through the second pad group 42012, the connecting wires, the first receiving pad S22, and the second portion of the plurality of first signal lines 3101, and the electrical signal is subsequently processed through the signal processing chip 320.

FIG. 23 is a diagram showing partial structures of a second silicon optical chip and a circuit sub-board in an optical module, in accordance with some embodiments. In some embodiments, as shown in FIG. 23, the second silicon optical chip 520 includes a second chip body 5200, a third pad group, a fourth pad group, and a second power signal pad. The third pad group, the fourth pad group, and the second power signal pad are disposed on a surface of the second chip body 5200 away from the circuit board 300 (e.g., an upper surface) and proximate to the signal processing chip 320. The second silicon optical chip 520 transmits the electrical signal to the signal processing chip 320 through the third pad group, and the second silicon optical chip 520 receives the electrical signal from the signal processing chip 320 through the fourth pad group. The second power signal pad is disposed between the third pad group and the fourth pad group, so as to reduce the interference of the transmitting signal to the receiving signal.

The third pad group includes a second transmitting signal pad and a third grounding signal pad disposed on at least one side of the second transmitting signal pad in the width direction of circuit board 300. The circuit sub-board 310 further includes a second transmitting pad, a third grounding pad, and a plurality of second signal lines 312 (as shown in FIG. 23). The second transmitting pad and the third grounding pad are disposed at the edge (e.g., a left edge) of the circuit sub-board 310 away from the connecting finger 340. The second transmitting signal pad corresponds to the second transmitting pad, and the third grounding signal pad corresponds to the third grounding pad.

For example, the second transmitting signal pad is electrically connected to the second transmitting pad through two connecting wires, and the third grounding signal pad is electrically connected to the third grounding pad through three connecting wires, thereby forming the return path. The plurality of second signal lines 312 are disposed on the first body 3100 and located on at least one side of the connecting hole 330 in a width direction (e.g., the front-rear direction in FIG. 23) of the circuit sub-board 310. An end of a first portion of the plurality of second signal lines 312 is located at the edge of the first body 3100 away from the signal processing chip 320 and connected to the second transmitting pad, and another end of the first portion of the plurality of second signal lines 312 is connected to the signal processing chip 320. In this way, the electrical connection between the signal processing chip 320 and the second silicon optical chip 520 may be achieved through the first portion of the plurality of second signal lines 312, the second transmitting pad, the connecting wires, and the second transmitting signal pad. It will be noted that the two second signal lines 312 in FIG. 23 are located on two sides of the connecting hole 330. Of course, the two second signal lines 312 may also be located on a same side of the two sides of the connecting hole 330, and the present disclosure is not limited thereto.

Similarly, the fourth pad group includes a second receiving signal pad and a fourth grounding signal pad disposed on at least one side of the second receiving signal pad in the width direction of the circuit board 300. The circuit sub-board 310 further includes a second receiving pad and a fourth grounding pad. The second receiving pad and the fourth grounding pad are disposed at the left edge of the circuit sub-board 310. The second receiving signal pad corresponds to the second receiving pad, and the fourth grounding signal pad corresponds to the fourth grounding pad.

For example, the second receiving signal pad is electrically connected to the second receiving pad through two connecting wires, and the fourth grounding signal pad is electrically connected to the fourth grounding pad through three connecting wires, thereby forming the return path. An end of a second portion of the plurality of second signal lines 312 is located at the edge of the first body 3100 away from the signal processing chip 320 and connected to the second receiving pad, and anther end of the second portion of the plurality of second signal lines 312 is connected to the signal processing chip 320. In this way, the electrical connection between the signal processing chip 320 and the second silicon optical chip 520 may be achieved through the second portion of the plurality of second signal lines 312, the second receiving pad, the connecting wires, and the second receiving signal pad.

In some embodiments, the second silicon optical chip 520 includes at least three second power signal pads arranged side by side in the second direction. The circuit sub-board 310 further includes at least three second power pads disposed at the left edge of the circuit sub-board 310, and the at least three second power pads are disposed side by side in the first direction. That is to say, an arrangement direction of the plurality of second power signal pads is perpendicular to an arrangement direction of the plurality of second power pads.

The following is described by considering an example in which the second silicon optical chip 520 includes three second power signal pads, and the circuit sub-board 310 includes three second power pads.

One second power signal pad located in the middle in the three second power signal pads is connected to a second power pad of the three second power pads most proximate to the one second power signal pad through at least two connecting wires, and the other two second power signal pads each are connected to the corresponding second power pad through at least two connecting wires. For example, the second power signal pad located in the middle in the three second power signal pads is electrically connected to the second power pad located on the left side in the three second power pads through two connecting wires. The second power signal pad located on a first side (e.g., the rear side) in the three second power signal pads is electrically connected to the second power pad located in the middle in the three second power pads through two connecting wires. The second power signal pad located on a second side (e.g., the front side) in the three second power signal pads is electrically connected to the second power pad located on the right side in the three second power pads through two connecting wires.

For example, the second silicon optical chip 520 includes a fourth power signal sub-pad, a fifth power signal sub-pad, and a sixth power signal sub-pad that are arranged side by side in the front-rear direction, and the fifth power signal sub-pad is located between the fourth power signal sub-pad and the sixth power signal sub-pad. The circuit sub-board 310 includes a fourth sub-pad, a fifth sub-pad, and a sixth sub-pad that are arranged side by side in the left-right direction, and the fifth sub-pad is located between the fourth sub-pad and the sixth sub-pad.

The fourth power signal sub-pad is connected to the sixth sub-pad through the connecting wires, the fifth power signal sub-pad is connected to the fourth sub-pad through the connecting wires, and the sixth power signal sub-pad is connected to the fifth sub-pad through the connecting wires.

The three second power signal pads are arranged between the third grounding signal pad of the third pad group and the fourth grounding signal pad of the fourth pad group. The three second power pads are disposed between the third grounding pad and the fourth grounding pad, and dimensions of the third grounding pad and the fourth grounding pad in the first direction each are greater than a dimension of the second power pad in the first direction. It will be noted that the dimensions of the third and fourth grounding pads in the first direction may be same or different from each other.

In some embodiments, the plurality of second power pads are sequentially arranged in the first direction, and an arrangement direction of the plurality of second power pads may be different from an arrangement direction of the plurality of second power signal pads. In this way, the connecting wires between the plurality of second power pads and the plurality of second power signal pads may be spatially interlaced and form interlaced return paths with the grounding circuits on the two sides of the plurality of second power pads, thereby avoiding the signal crosstalk between the transmitting signal and the receiving signal.

The second silicon optical chip 520 is electrically connected to the connecting finger 340 of the circuit board 300 through the second power signal pad, the connecting wires, the second power pad, and the corresponding power line. As a result, the electrical signal (e.g., the power signal) from the connecting finger 340 is transmitted to the circuit sub-board 310 through the power line and then transmitted to the edge of the circuit sub-board 310 through the inner layer and the surface layer of the circuit sub-board 310 and supplies power to the second silicon optical chip 520 through the second power pad, the connecting wires, and second power signal pad, so that the second silicon optical chip 520 may receive the external optical signal or the laser beam.

The second silicon optical chip 520 is electrically connected to the signal processing chip 320 through the third pad group, the fourth pad group, the connecting wires, the second transmitting pad, the second receiving pad, and the second signal lines 312. In this way, the electrical signal output by the signal processing chip 320 may be transmitted to the second silicon optical chip 520 through the first portion of the plurality of second signal lines 312, the second transmitting pad, the connecting wires, and the third pad group, so as to provide the electrical signal to the second silicon optical chip 520, so that the second silicon optical chip 520 may perform optical modulation on the laser beam according to the electrical signal, and the modulated optical signal is transmitted to the external optical fiber through the third optical fiber sub-strip 801. After the external optical signal is transmitted to the second silicon optical chip 520 through the fourth optical fiber sub-strip 802, the second silicon optical chip 520 processes the external optical signal into the electrical signal. The processed electrical signal is transmitted to the signal processing chip 320 through the fourth pad group, the connecting wires, the second receiving pad, and the second portion of the plurality of second signal lines 312, and the electrical signal is subsequently processed through the signal processing chip 320.

In some embodiments, after the signal transmission between the signal processing chip 320 and the first silicon optical chip 420 and the signal transmission between the signal processing chip 320 and the second silicon optical chip 520 are achieved through the first signal lines 3101 and the second signal lines 312, respectively, it is also necessary to supply power to the first light transceiver assembly 400 and the second light transceiver assembly 500 through the circuit board 300.

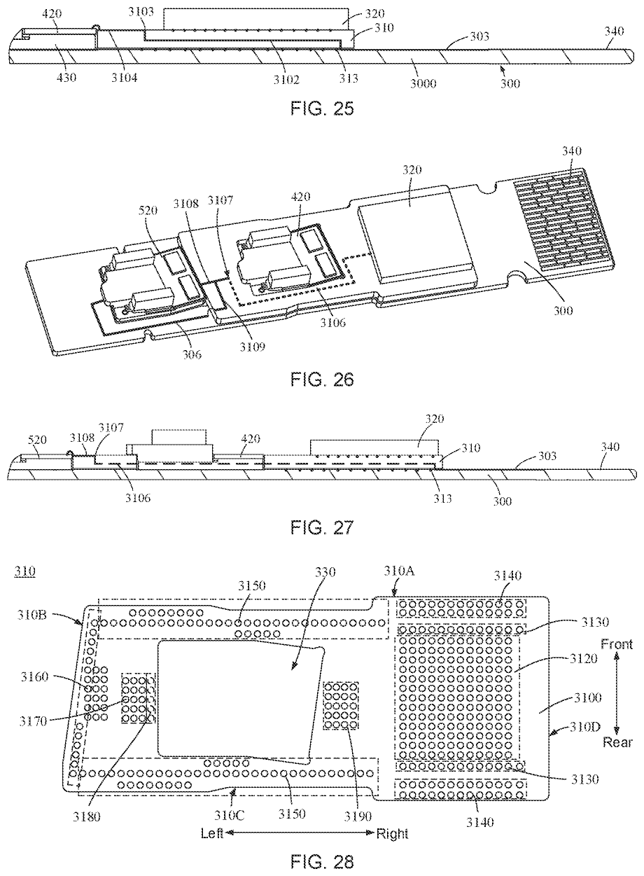

FIG. 24 is a diagram showing partial structures of a circuit board, a circuit sub-board, a signal processing chip, and a first light transceiver assembly in an optical module, in accordance with some embodiments. FIG. 25 is a sectional view of a circuit board, a circuit sub-board, a signal processing chip, and a first light transceiver assembly in an optical module, in accordance with some embodiments.

In some examples, as shown in FIGS. 24 and 25, the circuit sub-board 310 further includes a third solder ball 313. The circuit board 300 further includes a power signal line 303 disposed on the upper surface of the second body 3000. An end of the power signal line 303 is electrically connected to the connecting finger 340, and another end of the power signal line 303 is electrically connected to the third solder ball 313 of the circuit sub-board 310, so as to transmit the power signal from the connecting finger 340 to the circuit sub-board 310 and supply power to the first silicon optical chip 420 and the first laser device 4120 of the first light transceiver assembly 400 through the circuit sub-board 310. It will be noted that the power signal is also an electrical signal.

Since the signal processing chip 320 is connected to the upper surface of the circuit sub-board 310 through the first solder balls 3210, the third solder ball 313 on the lower surface of the circuit sub-board 310 is electrically connected to the inner layer of the circuit sub-board 310, so as to avoid the signal processing chip 320 on the upper surface of the circuit sub-board 310, so that power supply to the first silicon optical chip 420 and the first laser device 4120 may be achieved. Therefore, as shown in FIG. 25, the circuit sub-board 310 further includes a first power line 3102 and a first via hole 3103. The first power line 3102 is located inside the first body 3100. The first via hole 3103 is disposed in the first body 3100 and located on a side of the signal processing chip 320 away from the connecting finger 340, and the first via hole 3103 runs through the upper surface of the first body 3100 in the thickness direction of the circuit sub-board 310. An end of the first power line 3102 is electrically connected to the third solder ball 313, and another end of the first power line 3102 is electrically connected to the first silicon optical chip 420 through the first via hole 3103, so as to transmit the electrical signal to the first silicon optical chip 420.

The circuit sub-board 310 further includes a third power line 3104 and a fourth power line 3105 that are disposed on the upper surface of the first body 3100. An end of the third power line 3104 is electrically connected to the first power line 3102 through the first via hole 3103, and another end of the third power line 3104 is electrically connected to the first silicon optical chip 420 (e.g., the first power signal pad P1) through the connecting wires. The fourth power line 3105 is located on a side of the connecting hole 330. An end of the fourth power line 3105 is electrically connected to the first power line 3102 through the first via hole 3103, and another end of the fourth power line 3105 is electrically connected to the first laser device 4120 through the connecting wires.

In this way, by providing the third power line 3104 and the fourth power line 3105, the electrical signal from the connecting finger 340 may be transmitted from the inner layer of the circuit sub-board 310 to the surface of the circuit sub-board 310, and transmitted to the first silicon optical chip 420 and the first laser device 4120 through the connecting wires, so as to supply power to the first silicon optical chip 420 and the first laser device 4120.

After the first silicon optical chip 420 and the first laser device 4120 of the first light transceiver assembly 400 receive the electrical signal, the first laser device 4120 emits the laser beam, and the laser beam is transmitted to the first silicon optical chip 420 through the first collimating lens 4130, the first optical isolator 4140, the first converging lens 4150, and the first optical glass block 4160 in sequence, and the laser beam undergoes the electro-optic modulation within the first silicon optical chip 420, so that the emission of optical signal may be achieved.

FIG. 26 is a diagram showing partial structures of a circuit board, a circuit sub-board, a signal processing chip, a first light transceiver assembly, and a second light transceiver assembly in an optical module, in accordance with some embodiments. FIG. 27 is a sectional view of a circuit board, a circuit sub-board, a first light transceiver assembly, and a second light transceiver assembly in an optical module, in accordance with some embodiments.

As shown in FIGS. 26 and 27, the power signal line 303 of the circuit board 300 may also supply power to the second silicon optical chip 520 and the second laser device 5120 of the second light transceiver assembly 500 through the circuit sub-board 310.

The circuit sub-board 310 further includes a second power line 3106 and a second via hole 3107. The second power line 3106 is disposed inside the first body 3100 and located on at least one side of the connecting hole 330 in the width direction of the circuit sub-board 310. The second via hole 3107 is disposed in the first body 3100 and away from the first light transceiver assembly 400, and the second via hole 3107 runs through the upper surface of the first body 3100 in the thickness direction of the circuit sub-board 310. An end of the second power line 3106 is electrically connected to the third solder ball 313, and another end of the second power line 3106 is electrically connected to the second silicon optical chip 520 through the second via hole 3107, so as to transmit the electrical signal to the second silicon optical chip 520.

It will be noted that in a case where the second power line 3106 supplies power to the second silicon optical chip 520, it is necessary that the second power line 3106 is located on a side of the connecting hole 330, so as to avoid the mutual interference between the first power line 3102 connecting the first light transceiver assembly 400 and the second power line 3106 connecting the second light transceiver assembly 500.

The circuit sub-board 310 further includes a fifth power line 3108 and a sixth power line 3109, and the fifth power line 3108 and the sixth power line 3109 each are disposed on the upper surface of the first body 3100. An end of the fifth power line 3108 is electrically connected to the second power line 3106 through the second via hole 3107, and another end of the fifth power line 3108 is electrically connected to the second silicon optical chip 520 through the connecting wires. The sixth power line 3109 is located on a side of the connecting hole 330. An end of the sixth power line 3109 is electrically connected to the second power line 3106 through the second via hole 3107, and another end of the sixth power line 3109 is electrically connected to the second laser device 5120. For example, as shown in FIG. 26, the circuit board 300 further includes a seventh power line 306 disposed on the upper surface of the second body 3000. An end of the seventh power line 306 is connected to the another end of the sixth power line 3109 through the connecting wires, and another end of the seventh power line 306 is electrically connected to the second laser device 5120 through the connecting wires.

In this way, by providing the fifth power line 3108 and the sixth power line 3109, the electrical signal from the connecting finger 340 may be transmitted to the second silicon optical chip 520 and the second laser device 5120, so as to supply power to the second silicon optical chip 520 and second laser device 5120.

After the second silicon optical chip 520 and the second laser device 5120 of the second light transceiver assembly 500 receive the electrical signal, the second laser device 5120 emits the laser beam, and the laser beam is transmitted to the second silicon optical chip 520 through the second collimating lens 5130, the second optical isolator 5140, the second converging lens 5150, and the second optical glass block 5160 in sequence, and the laser beam undergoes the electro-optic modulation within the second silicon optical chip 520, so that the emission of optical signal may be achieved.

After the first light transceiver assembly 400 receives the power signal from the circuit board 300 and the electrical signal of the signal processing chip 320, the laser beam generated by the first laser device 4120 is incident into the first silicon optical chip 420. The first silicon optical chip 420 performs the electro-optic modulation on the laser beam according to the electrical signal of the signal processing chip 320, so as to form the optical signal. The modulated optical signal is transmitted to the external optical fiber through the first optical fiber sub-strip 701.

Similarly, after the second light transceiver assembly 500 receives the electrical signal from the circuit board 300 and the electrical signal of the signal processing chip 320, the laser beam generated by the second laser device 5120 is incident into the second silicon optical chip 520. The second silicon optical chip 520 performs the electro-optic modulation on the laser beam according to the electrical signal of the signal processing chip 320, so as to form the optical signal. The modulated optical signal is transmitted to the external optical fiber through the third optical fiber sub-strip 801.

After the first light transceiver assembly 400 receives the external optical signal, the external optical signal is transmitted into the first silicon optical chip 420 through the second optical fiber sub-strip 702. The first silicon optical chip 420 converts the optical signal into the electrical signal according to the electrical signal of the signal processing chip 320. The converted electrical signal is transmitted to the signal processing chip 320 for processing through the first signal line 3101.

Similarly, after the second light transceiver assembly 500 receives the external optical signal, the external optical signal is transmitted into the second silicon optical chip 520 through the fourth optical fiber sub-strip 802. The second silicon optical chip 520 converts the optical signal into the electrical signal according to the electrical signal of the signal processing chip 320. The converted electrical signal is transmitted to the signal processing chip 320 for processing through the second signal line 312.

FIG. 28 is a diagram showing a structure of a circuit sub-board in an optical module, in accordance with some embodiments.

In some embodiments, as shown in FIG. 28, the circuit sub-board 310 includes a first body 3100 and one or more first signal pads 3120. The first signal pad 3120 is disposed on the surface of the first body 3100 proximate to the circuit board 300 (e.g., the lower surface), and the first signal pad 3120 corresponds to the first solder ball 3210 of the signal processing chip 320. Moreover, the first signal pad 3120 is provided proximate to the connecting finger 340 of the circuit board 300. The first signal pad 3120 is connected to the upper surface of the circuit board 300, so that the electrical signal transmitted by the connecting finger 340 of the circuit board 300 may be transmitted to the circuit sub-board 310 through the first signal pad 3120 and then transmitted to the signal processing chip 320 through the circuit sub-board 310.

The first body 3100 includes a first edge 310A, a second edge 310B, a third edge 310C, and a fourth edge 310D that are sequentially connected. The first edge 310A is opposite to the third edge 310C, and the second edge 310B is opposite to the fourth edge 310D. The present disclosure does not limit the positions of the four edges.

For example, as shown in FIG. 28, in a case where an edge proximate to the first signal pad 3120 is the fourth edge 310D, an edge on a left side of the first body 3100 is the second edge 310B, and edges located on front and rear sides of the first body 3100 are the first edge 310A and the third edge 310C, respectively. It will be noted that, the front side and the rear side of the first body 3100 refer to the front side and the rear side shown in FIG. 28.

In some embodiments, as shown in FIG. 28, the circuit sub-board 310 further includes a plurality of first protecting pads 3130 disposed on the lower surface of the first body 3100, and the plurality of first protecting pads 3130 are located on at least two sides of the first signal pad 3120.

For example, as shown in FIG. 28, the plurality of first protecting pads 3130 include two groups of first protecting pads 3130, and the two groups of first protecting pads 3130 are disposed on a side of the first signal pad 3120 proximate to the first edge 310A and a side of the first signal pad 3120 proximate to the third edge 310C, respectively. The plurality of first protecting pads 3130 are adjacent to the first signal pad 3120, so as to protect the first signal pad 3120 and prevent the first signal pad 3120 from being damaged when the circuit sub-board 310 is installed.

In some embodiments, the first protecting pads 3130 are grounded. For example, after the circuit sub-board 310 is installed on the circuit board 300, the first signal pad 3120 on the lower surface of the circuit sub-board 310 is connected to the pad on the upper surface of the circuit board 300, and the first protecting pads 3130 on the lower surface of the circuit sub-board 310 are connected to the grounding pads on the upper surface of circuit board 300. In this way, the grounding connection between the circuit sub-board 310 and the circuit board 300 may be achieved through the plurality of first protecting pads 3130.

In addition, the plurality of first protecting pads 3130 may play a role in supporting the circuit sub-board 310 during the circuit sub-board 310 being arranged on the circuit board 300 through the surface mount technology (SMT), thereby avoiding the pseudo soldering due to inconsistent stress.

In some embodiments, as shown in FIG. 28, the circuit sub-board 310 further includes a plurality of second protecting pads 3150 and a plurality of third protecting pads 3160 that are disposed on the lower surface of the circuit sub-board 310.

For example, as shown in FIG. 28, the plurality of second protecting pads 3150 includes two groups of second protecting pads 3150 proximate to the first edge 310A and the third edge 310C, respectively. The plurality of third protecting pads 3160 are provided proximate to the second edge 310B. In this way, by providing the plurality of second protecting pads 3150 and the plurality of third protecting pads 3160, it is possible to play a role in supporting the edge of the circuit sub-board 310.

In some embodiments, as shown in FIG. 28, the circuit sub-board 310 further includes one or more second signal pads 3180 (i.e., the first pad 311). The second signal pad 3180 is disposed on a side of the connecting hole 330 proximate to the second edge 310B, and the second signal pad 3180 is electrically connected to the first laser device 4120 through the connecting wires, so as to supply the electrical signal for the first laser device 4120.

It will be noted that since the second signal pad 3180 is disposed on the upper surface of the first body 3100, in order to facilitate the description of the position of the second signal pad 3180, the second signal pad 3180 is shown with a dotted circle in FIG. 28.

In some embodiments, as shown in FIG. 28, the circuit sub-board 310 further includes one or more fourth protecting pads 3170 and one or more fifth protecting pads 3190. The fourth protecting pad 3170 and the fifth protecting pad 3190 are disposed on the lower surface of the first body 3100. The fourth protecting pad 3170 is located on a side of the second signal pad 3180 proximate to the second edge 310B. The fifth protecting pad 3190 is located on a side of the connecting hole 330 proximate to the fourth edge 310D. In this way, by providing the fourth protecting pad 3170 and the fifth protecting pad 3190, it is possible to play a role in supporting the edge of the circuit sub-board 310.

In some embodiments, as shown in FIG. 28, the circuit sub-board 310 further includes a plurality of sixth protecting pads 3140 disposed on the lower surface of the first body 3100. The plurality of sixth protecting pads 3140 are located on a side of the plurality of first protecting pads 3130 away from the first signal pad 3120 and located between the plurality of second protecting pads 3150 and the fourth edge 310D.

For example, as shown in FIG. 28, the plurality of sixth protecting pads 3140 include two groups of sixth protecting pads 3140. There are gaps between the two groups of first protecting pads 3130 and corresponding edges (e.g., the first edge 310A and the third edge 310C), and there are gaps between the second protecting pads 3150 and the fourth edge 310D. The two groups of sixth protecting pads 3140 are disposed within the gap between a group of first protecting pads 3130 and the first edge 310A and the gap between another group of first protecting pads 3130 and the third edge 310C, respectively, and the two groups of sixth protecting pads 3140 are located within the gaps between the two groups of second protecting pads 3150 and the fourth edge 310D, respectively.

In some embodiments, the second protecting pads 3150, the third protecting pads 3160, the fourth protecting pads 3170, the fifth protecting pads 3190, and the sixth protecting pads 3140 are grounded. After the circuit sub-board 310 is installed on the circuit board 300, the second protecting pads 3150, the third protecting pads 3160, the fourth protecting pads 3170, the fifth protecting pads 3190, and the plurality of sixth protecting pads 3140 that are located on the lower surface of the circuit sub-board 310 each are connected to the grounding pads on the upper surface of the circuit board 300, so as to achieve the grounding connection between the circuit sub-board 310 and the circuit board 300.

A person skilled in the art will understand that the scope of disclosure in the present disclosure is not limited to specific embodiments discussed above and may modify and substitute some elements of the embodiments without departing from the spirits of this disclosure. The scope of this disclosure is limited by the appended claims.

What is claimed is:

1. An optical module, comprising:
a circuit board configured to be electrically connected to an outside of the optical module;
a circuit sub-board disposed on the circuit board and electrically connected to the circuit board, and the circuit sub-board including:
a first body, a surface of the first body proximate to the circuit board being a lower surface, and a surface of the first body away from the circuit board being an upper surface;
a connecting hole running through the upper surface and the lower surface of the first body;
at least one first signal line disposed on the upper surface of the first body, an end of the first signal line being located at an edge of the connecting hole proximate to a signal processing chip; and
at least one second signal line disposed on the upper surface of the first body, an end of the second signal line being located at an edge of the first body away from the signal processing chip;
the signal processing chip disposed on the circuit sub-board, the signal processing chip being electrically connected to another end of the first signal line, and the signal processing chip being electrically connected to another end of the second signal line;
a first light transceiver assembly disposed on the circuit board and located in the connecting hole, the first light transceiver assembly being electrically connected to the end of the first signal line, and pads of the first light transceiver assembly being substantially coplanar with the upper surface of the first body, so as to shorten lengths of connecting wires between the first light transceiver assembly and the circuit sub-board; and
a second light transceiver assembly disposed on the circuit board and located outside the connecting hole, the second light transceiver assembly being electrically connected to the end of the second signal line, and pads of the second light transceiver assembly being substantially coplanar with the upper surface of the first body, so as to shorten lengths of connecting wires between the second light transceiver assembly and the circuit sub-board.

2. The optical module according to claim 1, wherein
the first light transceiver assembly includes:
a first light-emitting component configured to emit a light beam; and
a first silicon optical chip proximate to the signal processing chip, the first silicon optical chip being connected to the end of the first signal line through the connecting wire; wherein the light beam emitted by the first light-emitting component enters the first silicon optical chip, a surface of the first silicon optical chip connected to the connecting wire is substantially located on a same plane as a surface of the circuit sub-board away from the circuit board; and
the second light transceiver assembly includes:
a second light-emitting component configured to emit a light beam; and
a second silicon optical chip adjacent to an edge of the circuit sub-board away from the signal processing chip, the second silicon optical chip being connected to the end of the second signal line through the connecting wire; wherein the light beam emitted by the second light-emitting component enters the second silicon optical chip, and a surface of the second silicon optical chip connected to the connecting wire is substantially located on a same plane as the surface of the circuit sub-board away from the circuit board.

3. The optical module according to claim 2, further comprising:
a first optical fiber strip connected to the first light transceiver assembly;
a second optical fiber strip connected to the second light transceiver assembly;
an optical fiber adapter connected to the first light transceiver assembly and the second light transceiver assembly through the first optical fiber strip and the second optical fiber strip, respectively; and
a fixing frame disposed on the circuit board and located outside the second light transceiver assembly, and the fixing frame including:
a first fixing plate;
a second fixing plate disposed on the second silicon optical chip, two ends of the second fixing plate being connected to the first fixing plate and a third fixing plate, respectively; and
the third fixing plate disposed opposite to the first fixing plate, the first optical fiber strip being fixed on the first fixing plate and the third fixing plate.

4. The optical module according to claim 2, wherein
the circuit sub-board further includes a first pad disposed on an edge of the connecting hole away from the signal processing chip, the first pad is electrically connected to the first light-emitting component through the connecting wire, and the first pad is electrically connected to the circuit board, so as to supply power to the first light-emitting component; and
the circuit board includes a second body and a second pad disposed at a position of the second body proximate to the second light-emitting component, and the second pad is electrically connected to the second light-emitting component through the connecting wire, so as to supply power to the second light-emitting component.

5. The optical module according to claim 4, wherein
the first light transceiver assembly further includes a first housing covered on the first light-emitting component, and at least a portion of an end of the first housing away from the first silicon optical chip protrudes in a direction away from the first silicon optical chip, so as to constitute a first protrusion, and the first protrusion covers the connecting wire between the first pad and the first light-emitting component; and
the second light transceiver assembly further includes a second housing covered on the second light-emitting component, and at least a portion of an end of the second housing away from the second silicon optical chip protrudes in a direction away from the second silicon optical chip, so as to constitute a second protrusion, and the second protrusion covers the connecting wire between the second pad and the second light-emitting component.

6. The optical module according to claim 2, wherein the at least one first signal line includes a plurality of first signal lines;
the circuit sub-board further includes:
third pads connected to an end of a first portion of the plurality of first signal lines;
fourth pads connected to an end of a second portion of the plurality of first signal lines; and
a plurality of power pads electrically connected to the circuit board, so as to supply power to the first silicon optical chip;
the first silicon optical chip includes:
a chip body;
a first pad group disposed on the chip body, the first pad group being connected to the third pads through the connecting wires, and the first silicon optical chip transmitting electrical signals to the signal processing chip through the first pad group;
a second pad group disposed on the chip body, the second pad group being connected to the fourth pads through the connecting wires, and the first silicon optical chip receiving electrical signals from the signal processing chip through the second pad group; and
a plurality of power signal pads disposed on the chip body and located between the first pad group and the second pad group, the plurality of power signal pads being connected to the plurality of power pads through the connecting wires in an interlaced manner.

7. The optical module according to claim 6, wherein the plurality of power pads are arranged side by side in a first direction, the plurality of power signal pads are arranged side by side in a second direction, and the second direction is perpendicular to the first direction.

8. The optical module according to claim 7, wherein the plurality of power signal pads include a first power signal sub-pad, a second power signal sub-pad, and a third power signal sub-pad, and the second power signal sub-pad is located between the first power signal sub-pad and the third power signal sub-pad;
the plurality of power pads include a first sub-pad, a second sub-pad, and a third sub-pad, the second sub-pad is located between the first sub-pad and the third sub-pad;
wherein the first power signal sub-pad is connected to the third sub-pad through the connecting wire, the second power signal sub-pad is connected to the first sub-pad through the connecting wire, and the third power signal sub-pad is connected to the second sub-pad through the connecting wire.

9. The optical module according to claim 6, wherein
the first pad group includes:
a transmitting signal pad connected to the end of the first portion of the plurality of first signal lines; and
a first grounding signal pad located on at least one side of the transmitting signal pad in a width direction of the circuit board;
the second pad group includes:
a receiving signal pad connected to the end of the second portion of the plurality of first signal lines; and
a second grounding signal pad located on at least one side of the receiving signal pad in the width direction of the circuit board; and
the circuit sub-board further includes:
a first grounding pad connected to the first grounding signal pad; and
a second grounding pad connected to the second grounding signal pad;
wherein the plurality of power signal pads are located between the first grounding signal pad and the second grounding signal pad, and return paths are provided between the plurality of power signal pads and the first grounding signal pad and between the plurality of power signal pads and the second grounding signal pad.

10. The optical module according to claim 1, wherein
the signal processing chip includes:
a third body;
signal solder balls disposed on a side of the third body proximate to the circuit sub-board; and
at least one grounding solder ball disposed on a side of the third body proximate to the circuit sub-board and located outside the signal solder balls; and
the circuit sub-board satisfies one of following:
the circuit sub-board further includes:
third signal lines, an end of the third signal line being connected to the circuit board, and another end of the third signal line being connected to the signal solder ball; and
at least one grounding signal line, an end of the grounding signal line being connected to the circuit board, and another end of the grounding signal line being connected to the grounding solder ball;
and
the circuit sub-board further includes:
third signal lines, an end of the third signal line being connected to the circuit board, and the another end of the third signal line being connected to the signal solder ball; and
at least one grounding via hole, an end of the grounding via hole being connected to the circuit board, and another end of the grounding via hole being connected to the grounding solder ball.

11. The optical module according to claim 10, wherein the at least one grounding solder ball includes a plurality of grounding solder balls surrounding the signal solder balls;
the circuit sub-board satisfies one of following:
the at least one grounding signal line includes a plurality of grounding signal lines located on an outer periphery of the third signal lines, and the grounding signal lines and the third signal lines constitute return paths; and
the at least one grounding via hole includes a plurality of grounding via holes located on the outer periphery of the third signal lines, and the grounding via holes and the third signal lines constitute the return paths.

12. The optical module according to claim 1, wherein the circuit sub-board further includes:
a first power line disposed in the first body, an end of the first power line being electrically connected to the circuit board, and another end of the first power line being electrically connected to the first light transceiver assembly, so as to supply power for the first light transceiver assembly; and
a second power line disposed in the first body and located on at least one side of the connecting hole in a width direction of the circuit sub-board, an end of the second power line being electrically connected to the circuit board, and another end of the second power line being electrically connected to the second light transceiver assembly, so as to supply power to the second light transceiver assembly.

13. The optical module according to claim 1, wherein the first body includes a first edge, a second edge, a third edge, and a fourth edge connected in sequence, the first edge and the third edge are oppositely arranged, the second edge and the fourth edge are oppositely arranged; the circuit sub-board further includes:
a first signal pad disposed on the surface of the first body proximate to the circuit board and proximate to the fourth edge, the first signal pad being electrically connected to the circuit board, and the first signal pad being electrically connected to the signal processing chip;
a plurality of first protecting pads disposed on the surface of the first body proximate to the circuit board and located on at least two sides of the first signal pad, the plurality of first protecting pads being configured to support the first body;
a plurality of second protecting pads disposed on the surface of the first body proximate to the circuit board and proximate to at least one of the first edge or the third edge, the plurality of second protecting pads being configured to support the first body;
a plurality of third protecting pads disposed on the surface of the first body proximate to the circuit board and proximate to the second edge, the plurality of third protecting pads being configured to support the first body;
a second signal pad disposed on a side of the connecting hole proximate to the second edge and electrically connected to the first light transceiver assembly;
a plurality of fourth protecting pads disposed on the surface of the first body proximate to the circuit board and located on a side of the second signal pad proximate to the second edge, the plurality of fourth protecting pads being configured to support an edge of the connecting hole; and
a plurality of fifth protecting pads disposed on the surface of the first body proximate to the circuit board and located on a side of the connecting hole proximate to the fourth edge, the plurality of fifth protecting pads being configured to support an edge of the connecting hole.

14. An optical module, comprising:
a circuit board configured to be electrically connected to an outside of the optical module;
at least one circuit sub-board disposed on the circuit board and electrically connected to the circuit board, and the circuit sub-board including:
a first body, a surface of the first body proximate to the circuit board being a lower surface, and a surface of the first body away from the circuit board being an upper surface;
a connecting hole disposed at an end of the first body; and
a signal line disposed on the upper surface of the first body, an end of the signal line being located at an edge of the connecting hole proximate to at least one signal processing chip;
a light transceiver assembly disposed on the circuit board, at least a portion of the light transceiver assembly being located in the connecting hole, the light transceiver assembly being electrically connected to the end of the signal line, pads of the light transceiver assembly being substantially coplanar with the upper surface of the first body, so as to shorten lengths of connecting wires between the light transceiver assembly and the circuit sub-board; and
the at least one signal processing chip disposed on the circuit sub-board, the signal processing chip being electrically connected to another end of the signal line.

15. The optical module according to claim 14, wherein
the at least one circuit sub-board includes two circuit sub-boards;
the light transceiver assembly includes a first light transceiver assembly and a second light transceiver assembly arranged in the connecting holes of the two circuit sub-boards, respectively; and
the at least one signal processing chip includes two signal processing chips disposed on the two circuit sub-boards, respectively, the two signal processing chips are electrically connected to the first light transceiver assembly and the second light transceiver assembly through corresponding signal line, respectively.

16. The optical module according to claim 15, wherein the circuit board includes:
a first mounting region, the first light transceiver assembly being installed in the first mounting region through the connecting hole; and
a second mounting region, the second light transceiver assembly being installed in the second mounting region through the connecting hole; the second mounting region and the first mounting region are arranged side by side in a first direction.

17. The optical module according to claim 14, wherein the first body includes a first edge, a second edge, a third edge, and a fourth edge connected in sequence, the first edge and the third edge are oppositely arranged, the second edge and the fourth edge are oppositely arranged; the circuit sub-board further includes:
a first signal pad disposed on the surface of the first body proximate to the circuit board and proximate to the fourth edge, the first signal pad being electrically connected to the circuit board, and the first signal pad being electrically connected to the signal processing chip;
a plurality of first protecting pads disposed on the surface of the first body proximate to the circuit board and located on at least two sides of the first signal pad, the plurality of first protecting pads being configured to support the first body;
a plurality of second protecting pads disposed on the surface of the first body proximate to the circuit board and proximate to at least one of the first edge or the third edge, the plurality of second protecting pads being configured to support the first body; and
a plurality of third protecting pads disposed on the surface of the first body proximate to the circuit board and proximate to the second edge, the plurality of third protecting pads being configured to support the first body.

18. The optical module according to claim 17, wherein the circuit sub-board further includes:
a second signal pad disposed on a side of the connecting hole proximate to the second edge and electrically connected to the light transceiver assembly;
a plurality of fourth protecting pads disposed on the surface of the first body proximate to the circuit board and located on a side of the second signal pad proximate to the second edge, the plurality of fourth protecting pads being configured to support an edge of the connecting hole; and
a plurality of fifth protecting pads disposed on the surface of the first body proximate to the circuit board and located on a side of the connecting hole proximate to the fourth edge, the plurality of fifth protecting pads being configured to support an edge of the connecting hole.

19. The optical module according to claim 18, wherein the circuit sub-board further includes a plurality of sixth protecting pads disposed on the surface of the first body proximate to the circuit board, the plurality of sixth protecting pads are located on a side of the plurality of first protecting pads away from the first signal pad and located between the plurality of second protecting pads and the fourth edge.

20. The optical module according to claim 19, wherein the first protecting pads, the second protecting pads, the third protecting pads, the fourth protecting pads, the fifth protecting pads, and the sixth protecting pads each are grounded.
